(19) United States
(12) Patent Application Publication
(10) Pub. No.: US 2010/0075043 A1
(43) Pub. Date: Mar. 25, 2010

(54) INKJET RECORDING METHOD

(75) Inventors: Hideki Kaimoto, Shizuoka-ken (JP); Wataru Ono, Shizuoka-ken (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/535,687

(22) Filed: Aug. 5, 2009

(30) Foreign Application Priority Data
Sep. 19, 2008 (JP) 2008-241058

(51) Int. Cl. B05D 5/00

(52) U.S. Cl. 427/256

(57) ABSTRACT

The invention provides an inkjet recording method, including recording on an inkjet recording medium having, on a support, an ink receiving layer containing at least inorganic fine particles, polyvinyl alcohol-based polymer having a keto group, and a crosslinking agent, using inkjet ink containing at least a dye, water, and a water-soluble organic solvent in which 40% by mass or more of the water-soluble organic solvent is at least one member selected from the group consisting of ethylene glycol monoalkyl ether, diethylene glycol monoalkyl ether, propylene glycol monoalkyl ether, dipropylene glycol monoalkyl ether, 1,2-alkanediol, ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether. The inkjet recording method can provide a clear and high density recorded image and can suppress changes in hue from the hue obtained immediately after image printing.

### CROSS-REFERENCE TO RELATED APPLICATION

This application claims priority under 35 USC 119 from Japanese Patent Application No. 2008-241058 filed on Sep. 19, 2008, the disclosure of which is incorporated by reference herein.

### BACKGROUND OF THE INVENTION

1. Field of the Invention

The present invention relates to an inkjet recording method.

2. Related Art

With recent rapid development of the information technology industry, various information processing systems are being developed, and recording methods and recording devices suitable for each information processing system are also being put to practical use. Among these, an inkjet recording method has been increasingly widely used because the inkjet recording method has advantages in that the method allows recording on various recording materials, hardware (apparatus) is relatively inexpensive and compact, the method is excellent in quietness, and the like. Also, in recording utilizing the inkjet recording method, a so-called photo-like high-definition recorded article can be obtained.

A recording medium for inkjet recording is generally required to have properties, such as (1) quick-drying properties (high ink absorption rate), (2) proper and uniform dot diameter (no blur), (3) excellent granularity, (4) high dot circularity, (5) high color density, (6) high color saturation (no dullness), (7) excellent water resistance, lightfastness, and ozone resistance of an image area, (8) high whiteness degree, (9) high storage stability (no yellowing or image blur after prolonged storage), (10) resistance to deformation and excellent dimensional stability (low curling), and (11) excellent traveling properties in hardware.

In view of the above, a recording medium having an ink receiving layer having a porous structure has been put to practical use in recent years. According to the recording medium, excellent quick-drying properties and high glossiness are obtained. Moreover, an inkjet recording medium capable of providing a clear and high quality image and having excellent storage properties has been desired.

As an image printing method for obtaining a high density image, an inkjet recording method including performing heat treatment after image printing has been disclosed (e.g., Japanese Patent Application Laid-Open (JP-A) No. 2006-240298).

As another method for obtaining a high density image, inkjet ink has been variously examined, and an increase in printed image density depending on the content and type of water-soluble organic solvents contained in ink has been disclosed (e.g., JP-A No. 2005-336489). However, in recent years, the demand for image quality has increased more and more, and a high density image quality has been demanded.

In response to such a demand, in order to provide an inkjet recording material having a photo-like high glossiness, excellent ink absorption properties and water resistance, being free from problems of bending cracking or cracking of pigment ink, and having a high productivity, an inkjet recording material having ink receiving layers on a support in which at least one of the layers contains inorganic fine particles having an average secondary particle diameter of 500 nm or lower, a resin binder having a keto group, and a crosslinking agent therefor has been disclosed (e.g., JP-A No. 2005-145043).

Moreover, in order to provide an ink set that reduces staining of mutually different colors, especially a black ink and a color ink, and achieves excellent image quality without lowering an image density, an ink set containing a black ink composition containing a first colorant, water, and a first alkyl ether and a color ink composition containing a second colorant, water, and a second alkyl ether, in which the content of the first alkyl ether based on 100 parts by weight of the black ink composition is less than or equal to twice the content of the second alkyl ether based on 100 parts by weight of the color ink composition has been disclosed (e.g., JP-A No. 2005-336489).

Furthermore, in addition to properties such as image quality and storage properties, there is a problem, as a problem peculiar to the inkjet recording method, such that a hue changes with time from immediately after image printing and it takes time until an image is stabilized. In particular, when a material, such as another recording material, is partially overlapped on a recorded image which is not sufficiently dried, the hue of the recorded image may be different between the overlapped portion and the non-overlapped portion (i.e., an overlapping mark may be generated).

### SUMMARY OF THE INVENTION

The present invention has been made in view of the above circumstances, and aims to provide an inkjet recording method that can provide a clear and high density recorded image and can suppress changes in hue from the hue obtained immediately after image printing. More specifically, an aspect of the invention provides an inkjet recording method, comprising recording on an inkjet recording medium having, on a support, an ink receiving layer containing at least inorganic fine particles, polyvinyl alcohol-based polymer having a keto group, and a crosslinking agent, using inkjet ink containing at least a dye, water, and a water-soluble organic solvent in which 40% by mass or more of the water-soluble organic solvent is at least one member selected from the group consisting of ethylene glycol monoalkyl ether, diethylene glycol monoalkyl ether, propylene glycol monoalkyl ether, dipropylene glycol monoalkyl ether, 1,2-alkanediol, ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether.

### DETAILED DESCRIPTION OF THE INVENTION

The present inventors have conducted extensive researches on the above-described problems, and, as a result, have found, by recording (image printing) using inkjet ink containing a specific amount of specific water-soluble organic solvent, not only that a clear and high density recorded image can be obtained but also that the changes in hue from the hue obtained immediately after image printing can be remarkably improved. Moreover, it has been found that, by drying, as post treatment, the recording medium after image printing, the density of the recorded image can be further increased and the changes in hue can be further suppressed.

The inventors found, after studying hard the problems, that the objects to solve the problems may be achieved by the following items <1> to <10>. <1> An inkjet recording method comprising recording on an inkjet recording medium having, on a support, an ink receiving layer containing at least inorganic fine particles, polyvinyl alcohol-based polymer having a keto group, and a crosslinking agent, using inkjet ink containing at least a dye, water, and a water-soluble organic solvent in which 40% by mass or more of the water-soluble organic solvent is at least one member selected from the group consisting of ethylene glycol monoalkyl ether, diethylene glycol monoalkyl ether, propylene glycol monoalkyl ether, dipropylene glycol monoalkyl ether, 1,2-alkanediol, ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether.

<2> The inkjet recording method according to the item <1>, wherein the water-soluble organic solvent comprises 1,2-alkanediol, and the 1,2-alkanediol has 2 to 6 carbon atoms.

<3> The inkjet recording method according to the item <1> or the item <2>, wherein the water-soluble organic solvent comprises ethylene glycol monoalkyl ether, diethylene glycol monoalkyl ether, propylene glycol monoalkyl ether, or dipropylene glycol monoalkyl ether, and the ethylene glycol monoalkyl ether, diethylene glycol monoalkyl ether, propylene glycol monoalkyl ether, and dipropylene glycol monoalkyl ether each independently comprise an alkyl group in which a number of carbon atoms is 1 to 5.

<4> The inkjet recording method according to any one of the items <1> to <3>, wherein the water-soluble organic solvent comprises ethylene glycol dialkyl ether, diethylene glycol dialkyl ether, triethylene glycol dialkyl ether, propylene glycol dialkyl ether, dipropylene glycol dialkyl ether, or tripropylene glycol dialkyl ether, and the ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether each independently comprise an alkyl group in which a number of carbon atoms is 1 to 3.

<5> The inkjet recording method according to any one of the items <1> to <4>, wherein the water-soluble organic solvent further comprises glycerin.

<6> The inkjet recording method according to any one of the items <1> to <5>, wherein the dye is a water-soluble dye.

<7> The inkjet recording method according to any one of the items <1> to <6>, wherein the polyvinyl alcohol-based polymer is an acetoacetyl modified polyvinyl alcohol or a diacetone acrylamide modified polyvinyl alcohol.

<8> The inkjet recording method according to any one of the items of <1> to <7>, wherein a thickness of the ink receiving layer is 10 μm to 50 μm.

<9> The inkjet recording method according to any one of the items <1> to <8>, further comprising drying the inkjet recording medium after recording.

<10> The inkjet recording method according to any one of the items <1> to <9>, wherein the crosslinking agent comprises at least one water-soluble compound having two or more hydrazido groups or primary amino groups in a molecule thereof.

Hereinafter, the inkjet recording method of the invention will be described in detail.

The inkjet recording method of the invention includes recording on an inkjet recording medium having, on a support, an ink receiving layer containing at least inorganic fine particles, polyvinyl alcohol-based polymer containing a keto group, and a crosslinking agent, using inkjet ink containing at least a dye, water, and a water-soluble organic solvent. 40% by mass or more of the water-soluble organic solvent contained in the inkjet ink is at least one member selected from the group consisting of ethylene glycol monoalkyl ether, diethylene glycol monoalkyl ether, propylene glycol monoalkyl ether, dipropylene glycol monoalkyl ether, 1,2-alkanediol, ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether.

According to the inkjet recording method of the invention, a clear and high density recorded image can be obtained, and the changes in hue from the hue obtained immediately after image printing can be suppressed.

<Inkjet Ink>

The inkjet ink according to the invention contains at least a dye, water, and a water-soluble organic solvent, and, as required, may contain other ingredients. The inkjet ink of the invention may be at least one selected from the group consisting of yellow ink, magenta ink, cyan ink, and black ink and may be constituted as an ink set in which these inks are combined. Hereinafter, each ingredient contained in the inkjet ink according to the invention will be described below.

—Water-Soluble Organic Solvent—

The inkjet ink according to the present invention contains a water-soluble organic solvent. It is necessary in the invention that 40% or more by mass of the water-soluble organic solvent included in the inkjet ink comprises at least one water-soluble organic solvent (it may refer as a specific water-soluble organic solvent in some case) selected from the group consisting of ethylene glycol monoalkyl ether, diethylene glycol monoalkyl ether, propylene glycol monoalkyl ether, dipropylene glycol monoalkyl ether, 1,2-alkanediol, ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether.

As 1,2-alkanediol, 1,2-alkanediol having 2 to 6 carbon atoms is preferable, and ethylene glycol or 1,2-propanediol is more preferable.

A carbon number in each alkyl group of ethylene glycol monoalkyl ether, diethylene glycol monoalkyl ether, propylene glycol monoalkyl ether, and dipropylene glycol monoalkyl ether is preferably 1 to 5 respectively, and more preferably 1, 2 or 4.

A carbon number in each alkyl group of ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether is preferably 1 to 3 respectively, and more preferably 1, in order to achieve high printed image density with sufficient solubility in the ink liquid.

Among the above specific water-soluble organic solvents, ethylene glycol monomethyl ether, ethylene glycol monoethyl ether, ethylene glycol monobutyl ether, propylene glycol monomethyl ether, propylene glycol monoethyl ether, propylene glycol monobutyl ether, ethylene glycol dimethyl ether, diethylene glycol dimethyl ether (DEGDME), triethylene glycol dimethyl ether (TEGDME), propylene glycol dimethyl ether (PGDME), dipropylene glycol dimethyl ether (DPGDME), diethylene glycol monomethyl ether (DEGMME), diethylene glycol monobutyl ether (DEGMBE), dipropylene glycol monomethyl ether (DPGMME), dipropylene glycol monobutyl ether (DPGMBE), and tripropylene glycol dimethyl ether (TPGDME) are particularly preferable.

As a preferable combination of the specific water-soluble organic solvent and polyvinyl alcohol-based polymer containing a keto group, the combination of at least one member selected from the group consisting of ethylene glycol monoalkyl ether, diethylene glycol monoalkyl ether, 1,2-alkanediol, and propylene glycol monoalkyl ether and acetoacetyl modified polyvinyl alcohol is particularly preferable.

When the content of the specific water-soluble organic solvent is 40% by mass or more with respect to an entire mass of the water-soluble organic solvent contained in the inkjet ink, sufficient performance is obtained in terms of printed image density and changes in hue from the hue obtained immediately after image printing.

The content of the specific water-soluble organic solvent is more preferably 60% by mass or more, even more preferably 80% by mass or more, and particularly preferably 90% by mass or more with respect to the water-soluble organic solvent contained in the inkjet ink. By using the inkjet ink containing the above-mentioned specific amount of the specific water-soluble organic solvent, swelling of the binder after recording (image printing) can be suppressed when an image is recorded on an inkjet recording medium containing a specific water-soluble resin mentioned later, and an inkjet recorded image whose image density is high and in which the changes in hue after image printing are suppressed can be obtained.

Examples of water-soluble organic solvents usable for the inkjet ink of the invention other than the specific water-soluble organic solvent described above include, monovalent alcohols such as methanol, ethanol, propanol, isopropanol, butanol, isobutanol, sec-butanol, t-butanol, pentanol, hexanol, cyclohexanol and benzyl alcohol; polyhydric alcohols such as diethylene glycol, triethylene glycol, polyethylene glycol, 1,3-propanediol, dipropylene glycol, polypropylene glycol, 1,4-butanediol, 2,3-butanediol, 1,3-hexanediol, 1,3-pentanediol, glycerin, hexanetriol and thio diglycol; glycol derivatives such as ethylene glycol diacetate, ethylene glycol monomethyl ether acetate and ethylene glycol monophenyl ether; amines such as ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine and tetramethylpropylenediamine; and other polar solvents such as formamide, N,N-dimethylformamide, N,N-dimethylacetamide, dimethylsulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile and acetone.

Note that, the water-soluble organic solvents may be used solely or in a combination of two or more of them.

In the invention, the “water-soluble organic solvent” refers to an organic solvent that is not phase separated and is compatible with water when mixed with water.

The content of the water-soluble organic solvent in the inkjet ink according to the invention is preferably 5% by mass to 70% by mass, more preferably 10% by mass to 50% by mass, and particularly preferably 20% by mass to 40% by mass.

—Dye—

The inkjet ink according to the invention further contains at least one dye in addition to the water-soluble organic solvent. As the dye, general dyes usable for inkjet can be used. For example, in addition to dyes classified into an acid dye, a direct dye, a reactive dye, a vat dye, a sulfur dye, or a food dye in terms of Color Index, dyes classified into an oil-soluble dye, a basic dye, etc., can also be used.

Moreover, examples of the dye of the invention include an azo dye, an azomethine dye, a xanthene dye, and a quinone dye. Specific compounds of the dyes are listed below. However, the dyes used in the invention are not limited to the specific compounds below.

[C.I. Acid Yellow]

C.I. Acid Yellow Nos. 1, 3, 11, 17, 18, 19, 23, 25, 36, 38, 40, 42, 44, 49, 59, 61, 65, 67, 72, 73, 79, 99, 104, 110, 114, 116, 118, 121, 127, 129, 135, 137, 141, 143, 151, 155, 158, 159, 169, 176, 184, 193, 200, 204, 207, 215, 219, 220, 230, 232, 235, 241, 242, and 246.

[C.I. Acid Orange]

C.I. Acid Orange Nos. 3, 7, 8, 10, 19, 24, 51, 56, 67, 74, 80, 86, 87, 88, 89, 94, 95, 107, 108, 116, 122, 127, 140, 142, 144, 149, 152, 156, 162, 166, and 168.

[C.I. Acid Red]

C.I. Acid Red Nos. 1, 6, 8, 9, 13, 18, 27, 35, 37, 52, 54, 57, 73, 88, 97, 106, 111, 114, 118, 119, 127, 131, 138, 143, 145, 151, 183, 195, 198, 211, 215, 217, 225, 226, 249, 251, 254, 256, 257, 260, 261, 265, 266, 274, 276, 277, 289, 296, 299, 315, 318, 336, 337, 357, 359, 361, 362, 364, 366, 399, 407, and 415.

[C.I. Acid Violet]

C.I. Acid Violet Nos. 17, 19, 21, 42, 43, 47, 48, 49, 54, 66, 78, 90, 97, 102, 109 and 126.

[C.I. Acid Blue]

C.I. Acid Blue Nos. 1, 7, 9, 15, 23, 25, 40, 62, 72, 74, 80, 83, 90, 92, 103, 104, 112, 113, 114, 120, 127, 128, 129, 138, 140, 142, 156, 158, 171, 182, 185, 193, 199, 201, 203, 204, 205, 207, 209, 220, 221, 224, 225, 229, 230, 239, 249, 258, 260, 264, 278, 279, 280, 284, 290, 296, 298, 300, 317, 324, 333, 335, 338, 342 and 350.

[C.I. Acid Green]

C.I. Acid Green Nos. 9, 12, 16, 19, 20, 25, 27, 28, 40, 43, 56, 73, 81, 84, 104, 108 and 109.

[C.I. Acid Brown]

C.I. Acid Brown Nos. 2, 4, 13, 14, 19, 28, 44, 123, 224, 226, 227, 248, 282, 283, 289, 294, 297, 289, 301, 355, 357, and 413.

[C.I. Acid Black]

C.I. Acid Black Nos. 1, 2, 3, 24, 26, 31, 50, 52, 58, 60, 63, 107, 109, 112, 119, 132, 140, 155, 172, 187, 188, 194, 207 and222.

[C.I. Direct Yellow]

C.I. Direct Yellow Nos. 8, 9, 10, 11, 12, 22, 27, 28, 39, 44, 50, 58, 79, 86, 87, 98, 105, 106, 130, 132, 137, 142, 147 and 153.

[C.I. Direct Orange]

C.I. Direct Orange Nos. 6, 26, 27, 34, 39, 40, 46, 102, 105, 107 and 118.

[C.I. Direct Red]

C.I. Direct Red Nos. 2, 4, 9, 23, 24, 31, 54, 62, 69, 79, 80, 81, 83, 84, 89, 95, 212, 224, 225, 226, 227, 239, 242, 243 and 254.

[C.I. Direct Violet]

C.I. Direct Violet Nos. 9, 35, 51, 66, 94 and 95.

[C.I. Direct Blue]

C.I. Direct Blue Nos. 1, 15, 71, 76, 77, 78, 80, 86, 87, 90, 98, 106, 108, 160, 168, 189, 192, 193, 199, 200, 201, 202, 203, 218, 225, 229, 237, 244, 248, 251, 270, 273, 274, 290 and 291.

[C.I. Direct Green]

C.I. Direct Green Nos. 26, 28, 59, 80 and 85.

[C.I. Direct Brown]

C.I. Direct Brown Nos. 44, 106, 115, 195, 209, 210, 222 and 223.

[C.I. Direct Black]

C.I. Direct Black Nos. 17, 19, 22, 32, 51, 62, 108, 112, 113, 117, 118, 132, 146, 154, 159 and 169.

[C.I. Basic Yellow]

C.I. Basic Yellow Nos. 1, 2, 11, 13, 15, 19, 21, 28, 29, 32, 36, 40, 41, 45, 51, 63, 67, 70, 73 and 91.

[C.I. Basic Orange]

C.I. Basic Orange Nos. 2, 21 and 22.

[C.I. Basic Red]

C.I. Basic Red Nos. 1, 2, 12, 13, 14, 15, 18, 23, 24, 27, 29, 35, 36, 39, 46, 51, 52, 69, 70, 73, 82 and 109.

[C.I. Basic Violet]

C.I. Basic Violet Nos. 1, 3, 7, 10, 11, 15, 16, 21, 27 and 39.

[C.I. Basic Blue]

C.I. Basic Blue Nos. 1, 3, 7, 9, 21, 22, 26, 41, 45, 47, 52, 54, 65, 69, 75, 77, 92, 100, 105, 117, 124, 129, 147 and 151.

[C.I. Basic Green]

C.I. Basic Green Nos. 1 and 4.

[C.I. Basic Brown]

C.I. Basic Brown No. 1.

[C.I. Reactive Yellow]

C.I. Reactive Yellow Nos. 2, 3, 7, 15, 17, 18, 22, 23, 24, 25, 27, 37, 39, 42, 57, 69, 76, 81, 84, 85, 86, 87, 92, 95, 102, 105, 111, 125, 135, 136, 137, 142, 143, 145, 151, 160, 161, 165, 167, 168, 175 and 176.

[C.I. Reactive Orange]

C.I. Reactive Orange Nos. 1, 4, 5, 7, 11, 12, 13, 15, 16, 20, 30, 35, 56, 64, 67, 69, 70, 72, 74, 82, 84, 86, 87, 91, 92, 93, 95, and 107.

[C.I. Reactive Red]

C.I.Reactive Red Nos. 2, 3, 5, 8, 11, 21, 22, 23, 24, 28, 29, 31, 33, 35, 43, 45, 49, 55, 56, 58, 65, 66, 78, 83, 84, 106, 111, 112, 113, 114, 116, 120, 123, 124, 128, 130, 136, 141, 147, 158, 159, 171, 174, 180, 183, 184, 187, 190, 193, 194, 195, 198, 218, 220, 222, 223, 228 and 235.

[C.I. Reactive Violet]

C.I. Reactive Violet Nos. 1, 2, 4, 5, 6, 22, 23, 33, 36 and 38.

[C.I. Reactive Blue]

C.I. Reactive Blue Nos. 2, 3, 4, 5, 7, 13, 14, 15, 19, 21, 25, 27, 28, 29, 38, 39, 41, 49, 50, 52, 63, 69, 71, 72, 77, 79, 89, 104, 109, 112, 113, 114, 116, 119, 120, 122, 137, 140, 143, 147, 160, 161, 162, 163, 168, 171, 176, 182, 184, 191, 194, 195, 198, 203, 204, 207, 209, 211, 214, 220, 221, 222, 231, 235 and 236.

[C.I. Reactive Green]

C.I. Reactive Green Nos. 8, 12, 15, 19 and 21.

[C.I. Reactive Brown]

C.I. Reactive Brown Nos. 2, 7, 9, 10, 11, 17, 18, 19, 21, 23, 31, 37, 43 and 46.

[C.I. Reactive Black]

C.I. Reactive Black Nos. 5, 8, 13, 14, 31, 34 and 39.

[C.I. Food Black]

C.I. Food Black Nos. 1 and 2.

As a magenta dye, a cyan dye, a black dye, and a yellow dye usable for the inkjet ink according to the invention, the following dyes are also suitable.

More specifically, examples of the magenta dye usable for the inkjet ink according to the invention include aryl or heterocyclic azo dyes having, for example, phenols, naphthols, or anilines, as a coupler component; azomethine dyes having, for example, pyrazolones or pyrazolotriazoles, as a coupler component; methine dyes, such as an arylidene dye, a styryl dye, a merocyanine dye, a cyanine dye, or an oxonol dye; carbonium dyes, such as a diphenylmethane dye, a triphenylmethane dye, or a xanthene dye; quinone dyes, such as naphthoquinone, anthraquinone, or anthrapyridone; and condensed polycyclic dyes, such as a dioxazine dye, but are not limited thereto.

As the magenta dye, a heterocyclic azo dye is preferable and examples include substances mentioned in International Patent Publication Nos. 2002/83795 (pages. 35 to 55) and 2002-83662 (pages 27 to 42) and JP-A Nos. 2004-149560 (paragraphs [0046] to [0059]), 2004-149561 (paragraphs [0047] to [0060]), and 2007-70573 (paragraphs [0073] to [0082]).

Examples of the cyan dye usable for the inkjet ink according to the invention include aryl or heterocyclic azo dyes having, for example, phenols, naphthols, or anilines, as a coupler component; azomethine dyes having, for example, heterocycles, such as phenols, naphthols, or pyrrolotriazole, as a coupler component; polymethine dyes, such as a cyanine dye, an oxonol dye, or a merocyanine dye; carbonium dyes, such as a diphenylmethane dye, a triphenylmethane dye, or a xanthene dye; a phthalocyanine dye; an anthraquinone dye, and an indigo-thioindigo dye, but are not limited thereto.

An associative phthalocyanine dye is preferable and examples include substances mentioned in International Application Publication Nos. 2002/60994, 2003/811 and 2003/62324 and JP-A Nos. 2003-213167, 2004-75986, 2004-323605, 2004-315758, 2004-315807, 2005-179469, and 2007-70573 (paragraphs [0083] to [0090]).

Examples of the black dye usable for the inkjet ink according to the invention include a disazo dye, a trisazo dye, and a tetrakisazo dye. These black dyes may be used in combination with a pigment, such as a dispersion of carbon black.

Preferable examples of the black dye are mentioned in detail in JP-A Nos. 2005-307177 and 2006-282795 (paragraphs [0068] to [0087]).

Examples of the yellow dye usable for the inkjet ink according to the invention include substances mentioned in International Patent Publication WO 2005/075573, JP-A Nos. 2004-83903 (paragraphs [0024] to [0062]), 2003-277661 (paragraphs [0021] to [0050]), 2003-277262 (paragraphs [0042] to

), 2003-128953 (paragraphs [0025] to [0076]), and 2003-41160 (paragraphs [0028] to [0064]), and U.S. Patent Application Publication No. 2003/0213405 (paragraph [0108]), C.I. Direct Yellows 8, 9, 11, 12, 27, 28, 29, 33, 35, 39, 41, 44, 50, 53, 59, 68, 86, 87, 93, 95, 96, 98, 100, 106, 108, 109, 110, 130, 132, 142, 144, 161, and 163, C.I. Acid Yellows 17, 19, 23, 25, 39, 40, 42, 44, 49, 50, 61, 64, 76, 79, 110, 127, 135, 143, 151, 159, 169, 174, 190, 195, 196, 197, 199, 218, 219, 222, and 227, C.I. Reactive Yellows 2, 3, 13, 14, 15, 17, 18, 23, 24, 25, 26, 27, 29, 35, 37, 41, and 42, and C.I. Basic Yellows 1, 2, 4, 11, 13, 14, 15, 19, 21, 23, 24, 25, 28, 29, 32, 36, 39, and 40. Moreover, the yellow dyes mentioned in paragraphs [0013] to [0112] and [0114] to [0121] of JP-A No. 2007-191650 are preferable.

As dyes for use in the inkjet ink according to the invention, water-soluble dyes are preferable. The types of the water-soluble dyes are not limited, and are suitably selected considering color tones or the like required in the inkjet ink. In the invention, the “water-soluble dye” refers to dyes that are substantially water-soluble, and refers to dyes whose solubility in water at 20° C. is preferably 2% by mass or more and more preferably 5% by mass or more.

When the inkjet ink according to the invention is at least one selected from the group consisting of yellow ink, magenta ink, cyan ink, and black ink, each of the magenta dye and the cyan dye contained in the inkjet ink may be an anionic water-soluble dye, the water-soluble group of the anionic water-soluble dye may be a sulfonic acid group, and an Li+ ion or a quaternary ammonium ion may be used as a counter ion.

More specifically, in the invention, the water-soluble group of the anionic water-soluble dye in the magenta ink and the cyan ink can be specified as a sulfonic acid group and the counter ion thereof can be specified as an Li+ ion or a quaternary ammonium ion. The optimal counter ion is an Li+ ion.

Similarly, the yellow dyes and the black dyes contained in the yellow inks and the black inks are all anionic water-soluble dyes and the water-soluble group of the anionic water-soluble dye is a sulfonic acid group, a carboxy group, or a phenolic hydroxy group. It is preferable that, when the water-soluble group is a sulfonic acid group, an Li+ ion or a quaternary ammonium ion be used as a counter ion and that, when the water-soluble group is a carboxy group or a phenolic hydroxy group, a K+ ion or an Na+ ion be used as a counter ion.

As a preferable combination, when the water-soluble group is a sulfonic acid group, the counter ion is a Li+ ion. When the water-soluble group is a carboxy group or a phenolic hydroxy group, in order to give priority to the solubility of dyes in water, the counter ion is preferably a K+ ion and, in order to give priority to the interaction with dyes having a sulfonic acid group, an Na+ ion is preferable as a counter ion. They are suitably selected.

Thus, the water-soluble group and the counter ion have the optimal combination, and preferable counter ions for a sulfonic acid group and a carboxy group are different from each other. Therefore, it is preferable for the dyes not to simultaneously contain a sulfonic acid group and a carboxy group in the molecules.

The content of the dye contained in the inkjet ink according to the invention is preferably 0.5% by mass to 30% by mass and more preferably 1.0% by mass to 15% by mass. By adjusting the content to 0.5% by mass or more, printing density becomes favorable. By adjusting the content to 30% by mass or lower, an increase in viscosity of the inkjet ink and the generation of structural viscosity in the viscosity characteristics can be suppressed. Thus, favorable discharging stability of the ink from an inkjet head is achieved.

In order to increase the discharging stability, printing quality, image durability, etc., of the inkjet ink for use in the invention, additives, such as surfactants, drying inhibitors, penetration accelerators, urea additives, chelating agents, UV absorbers, antioxidants, viscosity controlling agents, surface tension regulators, dispersants, dispersion stabilizers, antiseptic agents, antifungal agents, anticorrosives, pH adjustors, defoaming agents, polymer materials, or acid precursors, mentioned in JP-A No. 2004-331871, etc., can be suitably selected for use. Preferable amounts of the additives are as described in JP-A No. 2004-331871 mentioned above.

Moreover, preferable ranges, measurement methods, adjustment methods, and the like of ink physical properties, such as pH, conductivity, viscosity, static surface tension, or dynamic surface tension of inkjet ink, are as described in JP-A No. 2004-331871.

Methods for preparing the inkjet ink are described in detail in each method of JP-A Nos. 5-148436, 5-295312, 7-97541, 7-82515, 7-118584, and 2004-331871, and also can be used for the preparation of the inkjet ink for use in the invention.

In the production of the inkjet ink, supersonic oscillation can also be added to, for example, a process for melting additives, such as dyes, as described in JP-A No. 2004-331871.

When the inkjet ink is produced, a process of removing wastes, which are solid, by filtration performed after liquid preparation is important. The filtering process is as described in JP-A No. 2004-331871.

<Inkjet Recording Medium>

The inkjet recording medium according to the invention includes, on a support, an ink receiving layer containing at least inorganic fine particles, polyvinyl alcohol-based polymer having a keto group, and a crosslinking agent, and may have other layers as required.

—Polyvinyl Alcohol-Based Polymer Having a Keto Group—

The inkjet recording medium according to the invention contains at least one polyvinyl alcohol-based polymer (hereinafter also referred to as a “specific water-soluble resin”) having a keto group as a binder. The polyvinyl alcohol-based polymer having a keto group can be synthesized by a method that, for example, a monomer having a keto group and a vinyl ester monomer are copolymerized, and thereafter ester groups of the obtained copolymer are hydrolyzed to alcohol groups. Specific examples of the monomer having a keto group include acrolein, diacetone acrylamide, diacetone methacrylate, acetoacetoxylethyl methacrylate, 4-vinylacetoacetanilide, and acetoacetylallylamide. A keto group may be introduced by a polymer reaction, and, for example, an acetoacetyl group can be introduced by a reaction of a hydroxy group and diketene.

Specific examples of the specific water-soluble resin include acetoacetyl modified polyvinyl alcohol and diacetone acrylamide modified polyvinyl alcohol.

The acetoacetyl modified polyvinyl alcohol can be produced by a known method, such as a reaction of polyvinyl alcohol and diketene. An acetoacetylation degree is preferalby 0.1 mol % to 20 mol % and more preferably 1 mol % to 15 mol %. The saponification degree is preferably 80 mol % or more and more preferably 85 mol % or more. The number average degree of polymerization is preferably 500 to 5,000 and particularly preferably 1,000 to 4,500.

The diacetone acrylamide modified polyvinyl alcohol can be produced by a known method, such as a method including saponifying a diacetone acrylamide-vinyl acetate copolymer. The content of a diacetone acrylamide unit is preferably in the range of 0.1 mol % to 15 mol % and more preferably 0.5 mol % to 10 mol %. The saponification degree is preferably 85 mol % or more and the number average degree of polymerization is preferably 500 to 5,000.

The specific water-soluble resin has a hydroxy group in the structural unit thereof. The hydroxy group and a silanol group on the surface of silica fine particles form a hydrogen bond to thereby facilitate the formation of a three-dimensional network structure having secondary particles of the silica fine particles as a chain unit. It is considered that, by the formation of such a three-dimensional network structure, an ink receiving layer of a porous structure having a high porosity can be formed.

In the inkjet recording medium, the porous ink receiving layer thus obtained rapidly absorbs ink due to a capillary phenomenon, thereby forming favorable dots having a high circularity and having no ink blur.

The specific water-soluble resin may be used singly or in a combination of two or more of them.

In the invention, other known water-soluble resins may be used in combination in addition to the specific water-soluble resin.

Examples of the water-soluble resin include polyvinyl alcohol-based resins having a hydroxy group as a hydrophilic structural unit [polyvinyl alcohol (PVA), cation modified polyvinyl alcohol, anion modified polyvinyl alcohol, silanol modified polyvinyl alcohol, polyvinyl acetal, etc.], cellulose based resins [methyl cellulose (MC), ethyl cellulose (EC), hydroxyethyl cellulose (HEC), carboxymethyl cellulose (CMC), hydroxypropyl cellulose (HPC), hydroxyethyl methyl cellulose, hydroxypropyl methyl cellulose, etc.], chitins, chitosans, starch, or resins having an ether bond [polyethylene oxide (PEO), polypropylene oxide (PPO), polyethylene glycol (PEG), polyvinyl ether (PVE), etc.,], and resins having a carbamoyl group [polyacrylamide (PAAM), polyvinyl pyrrolidone (PVP), polyacrylic acid hydrazide, etc.]. Examples of the water-soluble resin further include polyacrylate, maleic acid resin, alginic acid salts, and gelatins each having a carboxy group as a dissociative group.

Among the above, the polyvinyl alcohol-based resin is preferable and polyvinyl alcohol is particularly preferable.

In the invention, the “water-soluble resin” refers to a resin that finally dissolves in 100 g of water at 20° C. in an amount of 0.05 g or more and preferably 0.1 g or more through a heating or cooling process.

When a polyvinyl alcohol-based resin is used as the known water-soluble resin other than the specific water-soluble resins, the number average degree of polymerization of the polyvinyl alcohol-based resin is preferably 1,800 or more and more preferably 2,000 or more from the viewpoint of inhibiting cracking. When silica fine particles are used as inorganic fine particles, the type of the water-soluble resin becomes important from the viewpoint of transparency. Particularly when anhydrous silica is used, polyvinyl alcohol-based resins are preferably used as the water-soluble resin and polyvinyl alcohol-based resins having a saponification degree of 70% to 99% are more preferably used.

As the polyvinyl alcohol based resins, derivatives of the specific example are also included, and the polyvinyl alcohol based resins may be used alone or in a combination of two or more of them.

When other known water-soluble resins are used in combination in addition to the specific water-soluble resin, water-soluble resins having high compatibility with the specific water-soluble resin are preferably used in combination in terms of glossiness and, for example, completely or partially saponified polyvinyl alcohol or cation modified polyvinyl alcohol can be preferably used in combination. In particular, water-soluble resins having a degree of saponification of 80% or more and a number average degree of polymerization of 200 to 5,000 can be preferably used.

Examples of the cation modified polyvinyl alcohol include polyvinyl alcohol-based polymer having a primary to tertiary amino group or a quaternary ammonium group in the main chain or the side chain of polyvinyl alcohol as described in JP-A No. 61-10483.

The above-mentioned known water-soluble resins and inorganic fine particles mentioned later mainly constituting the ink receiving layer may be individually a single raw material or a mixture of a plurality of raw materials.

The content of the above-mentioned specific water-soluble resin (polyvinyl alcohol-based polymer having a keto group) is preferably 9% by mass to 40% by mass and more preferably 12% by mass to 33% by mass with respect to the total solid mass of the ink receiving layer from the viewpoints of preventing a reduction in film strength or cracking at the time of drying when the content is excessively small and preventing a reduction in ink absorption properties caused by that the void is likely to be blocked by resin to reduce the porosity when the content is excessively large.

The amount ratio (mass ratio) of the specific water-soluble resin to the known water-soluble resin other than specific water-soluble resin (specific water-soluble resin: known water-soluble resin) is preferably 10:0 to 5:5 and more preferably 10:0 to 7:3.

Hereinafter, both the specific water-soluble resin (polyvinyl alcohol-based polymer having a keto group) and the known water-soluble resin other than specific water-soluble resin are simply collectively referred to as a “water-soluble resin” as required.

(Inorganic Fine Particles)

The ink receiving layer according to the present invention contains at least one type of inorganic fine particles. Examples of the inorganic fine particles include particles of silica fine particles, colloidal silica, titanium dioxide, barium sulfate, calcium silicate, zeolite, kaolinite, halloysite, mica, talc, calcium carbonate, magnesium carbonate, calcium sulfate, alumina fine particles, boehmite, and pseudoboehmite. Among these particles, silica fine particles, colloidal silica, alumina fine particles, and pseudoboehmite are preferable. Particularly, vapor-phase process silica fine particles are preferable.

The silica fine particles in the above have an extremely high specific surface area, accordingly it provides an ink receiving layer with a higher ink absorption property and retention efficiency. In addition, the silica fine particles have a low refractive index, and thus if dispersed to a suitable particle diameter, provides the ink receiving layer with better transparency, and higher color density and favorable coloring is obtainable. The transparency of ink receiving layer is important from the viewpoints of obtaining a high color density, favorable coloring, and favorable glossiness not only for applications wherein the transparency is required such as OHP sheets and the like, but also for applications as recording sheets such as photographic glossy papers and the like.

The average primary particle diameter of the inorganic fine particles is preferably 20 nm or less, more preferably 15 nm or less, and particularly preferably 10 nm or less. In the case where the average primary particle size is 20 nm or less, the ink absorption property can be effectively improved and at the same time, the glossiness of the surface of the ink receiving layer can be enhanced.

In particular with silica fine particles, since the surface has silanol groups, the particles easily adhere to each other through hydrogen bond of the silanol groups, and there is an adhesion effect between the particles through the silanol groups and the water-soluble resin. Hence, when the average primary particle diameter is 20 nm or less, the porosity of the ink receiving layer is high, and a structure with high transparency can be formed, and the ink absorption property can be effectively raised.

Silica fine particles are commonly classified roughly into wet method particles and dry method (vapor-phase process) particles according to the method of manufacture. By the wet method, silica particles are mainly produced by generating an activated silica by acid decomposition of a silicate, polymerizing the activated silica to a proper degree, and coagulating and precipitating the resulting polymeric silica to give a hydrated silica. Alternatively by the vapor-phase process, an anhydrous silica is mainly produced by high-temperature vapor-phase hydrolysis of a silicon halide (flame hydrolysis process), or by reductively heating and vaporizing quartz sand and coke in an electric furnace by applying an arc discharge and then oxidizing the vaporized silica with air (arc method).

The vapor-phase process silica (anhydrous silica fine particles produced by vapor-phase process) is different in the density of silanol groups on the surface and the presence of voids therein and exhibits different properties from hydrated silica. The vapor-phase process silica is suitable for forming a three-dimensional structure having a higher porosity. The reason is not clearly understood. Hydrated silica fine particles have a higher density of 5 to 8 silanol groups/nM² on their surface. Thus the silica fine particles tend to coagulate densely. While the vapor-phase process silica fine particles have a lower density of 2 to 3 silanol groups/nm² on their surface. Therefore, vapor-phase process silica seems to cause more scarce, softer coagulations (flocculates), consequently leading to a structure having a higher porosity.

In the present invention, the vapor-phase process silica fine particles (anhydrous silica) obtained by the above wet method are preferable, and silica fine particles having a density of 2 to 3 silanol groups/nm² on their surface are more preferable.

<Content Ratio of Inorganic Fine Particles to Water-Soluble Resin (PB Ratio)>

The content ratio (PB ratio: x/y, a mass of inorganic fine particles with respect to 1 part by mass of water-soluble resin) of the inorganic fine particles (preferably silica fine particles; x) to the water-soluble resin (y) has a great influence on the structure of the ink receiving layer. A larger content ratio (PB ratio) tends to result in increase in porosity, pore volume, and surface area (per unit mass).

When an inkjet recording medium goes past a transportation system of an inkjet printer, in some cases, it receives stress; accordingly, the ink receiving layer necessarily has sufficient film strength. Furthermore, when the inkjet recording medium is cut in sheet, in order to inhibit the ink receiving layer from cracking and peeling as well, the ink receiving layer is necessary to have sufficient film strength. Thus the PB ratio is preferably 4.5 or less from the viewpoint of increasing hardness of the ink receiving layer. Further the PB ratio is more preferably 4.3 or less, and even more preferably 4.15 or less.

Though not particularly limited, in order to prevent reduction of ink absorption property caused by blocking of voids by resin, the PB ratio is preferably 1.5 or more. Furthermore, from the viewpoint of assuring high speed ink absorbing, the PB ratio is preferably 2 or more.

For example, when a coating solution, containing anhydrous silica fine particles, having an average primary particle diameter of 20 nm or less, and a water-soluble resin thoroughly dispersed in an aqueous solution at a PB ratio (x/y) of from 2/1 to 4.5/1, is applied and dried on a support, a three-dimensional network structure having secondary particles of silica fine particles as the network chains is formed. Such a coating solution easily provides a light-transmitting porous layer having an average void diameter of 30 nm or less, a porosity of 50% to 80%, a micropore specific volume of 0.5 mL/g or more, and a specific surface area of 100 m²/g or more.

(Crosslinking Agent)

The ink receiving layer according to the present invention contains at least one kind of crosslinking agents.

With respect to the ink receiving layer according to the invention, it is preferable that the layer containing a specific water-soluble resin and the like contains additionally a crosslinking agent that allows crosslinking of the specific water-soluble resin, and thus is a porous layer hardened by the crosslinking reaction between the crosslinking agent and the specific water-soluble resin. By adding the crosslinking agent, the specific water-soluble resin is crosslinked, as a result, a highly hardened ink receiving layer can be obtained.

As the crosslinking agent, a suitable crosslinking agent may be selected in connection with the specific water-soluble resin contained in the ink receiving layer. In particular, from the viewpoints of not only prompt crosslinking reaction but also, when used in combination with the specific water-soluble resin, suppressing swelling due to an ink solvent after inkjet recording, increasing the transparency of the ink receiving layer, and increasing the coloring density, it is preferable to use at least one of water-soluble compounds having two or more hydrazido groups or primary amino groups in the molecules and zirconium compounds. The zirconium compounds not only function as a crosslinking agent but also further increase ozone resistance, image blur resistance, and glossiness.

### —Water-Soluble Compound Having Two or More Hydrazido Groups or Primary Amino Groups in a Molecule Thereof—

The water-soluble compounds having two or more hydrazido groups or primary amino groups in the molecules refer to water-soluble compounds having two or more functional groups of either hydrazido groups (—CONH—NH₂) or primary amino groups (—NH₂) in the molecules. Therefore, water-soluble compounds having two or more hydrazido groups only, water-soluble compounds having two or more primary amino groups only, and water-soluble compounds having a combination of hydrazido groups and primary amino groups so that the total number of hydrazido groups and primary amino groups is 2 or more may be used.

Examples of the water-soluble compound having two or more hydrazido groups or primary amino groups in the molecule include water-soluble compounds having a group in which a primary amino group is bonded to a carbon atom of a divalent aliphatic group, a divalent aromatic group, or a divalent heterocyclic group or water-soluble compounds having a group in which a primary amino group is bonded to a nitrogen atom of a divalent group having a nitrogen atom.

In terms of an thickening effect at the time of preparing a coating solution for the ink receiving layer or a crosslinking agent solution, water-soluble compounds having a hydrazine type primary amino group (—HN—NH₂) are preferable, water-soluble compounds having a hydrazido structure are more preferable, and water-soluble compounds having two or more hydrazido groups in the molecules are particularly preferable.

Specific examples of the water-soluble compound having two or more primary amino groups (—NH₂) in the molecules include polyamine compounds having two or more primary amino groups, such as ethylenediamine, diethylenetriamine, metaxylylene diamine, norbornane diamine, 1,3-bis(aminomethyl)cyclohexane, a melamine resin (e.g., methylol melamine and alkylated methylol melamine), or tetraethylenepentamine, hydrazine, and salts thereof.

Specific examples of the water-soluble compound having two or more hydrazido groups in the molecule include polycarboxylic acid hydrazides, such as carbohydrazide, succinic acid dihydrazide, adipic acid dihydrazide, citric acid trihydrazide, sebacic acid dihydrazide, or isophthalic acid dihydrazide, reaction products of polyisocyanate, such as 4,4′-ethylenedisemicarbazide or 4,4′-hexamethylenedisemicarbazide, and hydrazine, and polymeric hydrazide, such as polyacrylic acid hydrazide.

Specific examples of the water-soluble compound having both of a hydrazido group and a primary amino group include semicarbazide.

Among the water-soluble compounds having two or more hydrazido groups or primary amino groups in the molecules, the water-soluble compounds having two or more hydrazido groups in the molecules are preferable, and succinic acid dihydrazide and adipic acid dihydrazide are particularly preferable in terms of water solubility and reactivity.

### —Zirconium Compound —

Examples of the zirconium compound include zirconyl acetylacetonate, zirconyl acetate, zirconium sulfate, zirconyl ammonium carbonate, zirconyl stearate, zirconyl octylate, zirconyl nitrate, zirconyl oxychloride, and zirconyl hydroxychloride.

Among the above, zirconyl containing compounds (water-soluble zirconyl compounds), such as zirconyl acetylacetonate, zirconyl acetate, zirconyl sulfate, zirconyl ammonium carbonate, zirconyl stearate, zirconyl octylate, zirconyl nitrate, zirconyl oxychloride, and zirconyl hydroxychloride are preferable, and zirconyl acetate, zirconyl ammonium carbonate, and zirconyl oxychloride are particularly preferable.

The water-soluble compounds having two or more hydrazido groups or primary amino groups in the molecules or the zirconium compounds may be used alone or as a mixture of two or more.

The water-soluble compound having two or more hydrazido groups or primary amino groups in the molecule or the zirconium compounds is preferably used in the range of 0.1% by mass to 50% by mass and more preferably 1% by mass to 20% by mass with respect to the specific water-soluble resin in terms of effects of suppressing swelling due to an ink solvent after inkjet recording, increasing the transparency of the ink receiving layer, increasing a coloring density, and preventing cracking at the time of drying after coating.

—Other Crosslinking Agents Used In Combination—

The following compounds may be used in combination with the above described water-soluble compound having two or more hydrazido groups or primary amino groups in a molecule thereof, or zirconium compound as a crosslinking agent for the polyvinyl alcohol-based polymer such as the specific water-soluble resin. Examples of the other crosslinking agent include borax, boric acid, borate salts [e.g., orthoborate salts, InBO₃, ScBO₃, YBO₃, LaBO₃, Mg₃(BO₃)₂, and Co₃(BO₃)₂], diborate salts [e.g., Mg₂B₂O₅, and Co₂B₂O₅], metaborate salts [e.g., LiBO₂, Ca(BO₂)₂, NaBO₂, and KBO₂], tetraborate salts [e.g., Na₂B₄O₇.10H₂O], pentaborate salts [e.g., KB₅O₈.4H₂O, Ca₂B₆O₁₁.7H₂O, and CsB₅O₅], and the like. Among them, borax, boric acid and borates are preferable since they are able to promptly cause a crosslinking reaction. Particularly, boric acid is preferable.

In the invention, when boric acid is used in combination as the crosslinking agent, the content of boric acid is preferably 5% by mass to 50% by mass and more preferably 8% by mass to 30% by mass with respect to the water-soluble resin in order to suppress swelling of the water-soluble resins, such as the specific water-soluble resins, to thereby sufficiently obtain the effects of the invention without causing problems of cracking or damage of an ink receiving layer.

Examples of such crosslinking agents used in combination with a main crosslinking agent include: aldehyde compounds such as formaldehyde, glyoxal and glutaraldehyde; ketone compounds such as diacetyl and cyclopentanedione; active halogen compounds such as bis(2-chloroethylurea), 2-hydroxy-4,6-dichloro-1,3,5-triazine and 2,4-dichloro-6-S-triazine sodium salt; active vinyl compounds such as divinyl sulfonic acid, 1,3-bis(vinylsulfonyl)-2-propanol, N,N′-ethylenebis(vinylsulfonylacetamide) and 1,3,5-triacryloyl-hexahydro-S-triazine; N-methylol compounds such as dimethylolurea and methylol dimethylhydantoin; epoxy resins;

isocyanate compounds such as 1,6-hexamethylenediisocyanate; aziridine compounds such as those described in U.S. Pat. Nos. 3,017,280 and 2,983611; carboxyimide compounds such as those described in U.S. Pat. No. 3,100,704; epoxy compounds such as glycerol triglycidyl ether; ethyleneimino compounds such as 1,6-hexamethylene-N,N′-bisethylene urea; halogenated carboxyaldehyde compounds such as mucochloric acid and mucophenoxychloric acid; dioxane compounds such as 2,3-dihydroxydioxane; and low molecular compounds or polymers containing at least two oxazoline groups.

Furthermore, as the crosslinking agent of the water-soluble resin in the invention, polyvalent metal compounds other than zirconium compounds cited below may also be preferably used in combination with the main crosslinking agent. The polyvalent metal compound not only works as the crosslinking agent but also further improves the ozone resistance, image blur resistance and glossiness.

As the polyvalent metal compound, water-soluble compounds are preferable. Examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, copper (II) chloride, ammonium copper (II) chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminum sulfate, chromium alum, potassium alum, aluminum alum, aluminum sulfite, aluminum thiosulfate, polyaluminum chloride, aluminum nitrate nonahydrate, aluminum chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetraisopropyl titanate, titanium acetyl acetonate, titanium lactate, chromium acetate, chromium sulfate, magnesium sulfate, magnesium chloride hexahydrate, magnesium citrate nonahydrate, sodium phosphorustungstate, sodium tungsten citrate, 12 tungstophosphoric acid n-hydrate, 12 tungstosilic acid 26-hydrate, molybdenum chloride, 12-molybdophosphoric acid n-hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride and bismuth nitrate.

Among the foregoing polyvalent metal compounds, preferable example include aluminum-containing compounds (water-soluble aluminum compounds) such as aluminum sulfate, aluminum alum, aluminum sulfite, aluminum thiosulfate, polyaluminum chloride, aluminum nitrate nonahydrate and aluminum chloride hexahydrate; and titanium-containing compounds such as titanium tetrachloride, tetraisopropyl titanate, titanium acetyl acetonate and titanium lactate. Among these, polyaluminum chloride is particularly preferable.

The crosslinking agents may be used alone or in a combination of two or more kinds. From the viewpoints of working as a preferable crosslinking agent and of further improving the ozone resistance, image blur resistance and glossiness, the polyvalent metal compound (particularly preferably, zirconyl compound) is contained, relative to the water-soluble resin, preferably in an amount of 0.1% by mass or more, more preferably 0.5% by mass or more and particularly preferably 1.0% by mass or more. Furthermore, the upper limit of the content of the polyvalent metal compound, though not particularly limited, from the viewpoints of image density, ink absorption property and suppression of curl of the recording medium, is preferably 50% by mass.

(Ammonium Carbonate)

In the ink receiving layer according to the invention, ammonium carbonate is preferably further contained. When ammonium carbonate is contained in the ink receiving layer, an ink receiving layer high in the hardness can be obtained.

A content of the ammonium carbonate is, relative to the water-soluble resin, preferably 8% by mass or more, more preferably 9% by mass or more and particularly preferably 11% by mass or more. Furthermore, the upper limit of the content thereof, though not particularly limited, from the viewpoints of the image density, ink absorption property and suppression of curl of the recording medium, is preferably 20% by mass.

(Water Dispersible Cationic Resin)

Furthermore, the ink receiving layer according to the invention may contain a water dispersible cationic resin. As the water dispersible cationic resin, a polymer that is a cation-modified self-emulsifiable polymer is described. A urethane resin is preferable. The glass transition temperature of the water dispersible cationic resin is preferably lower than 50° C.

The “cation-modified self-emulsifiable polymer” means a polymer that can naturally form stable emulsified dispersion in an aqueous dispersion medium without using an emulsifier or surfactant or with only a slight amount thereof added. Quantitatively, the “cation-modified self-emulsifiable polymer” represents a polymer that has stable emulsified dispersibility at a concentration of 0.5% by mass or more relative to the aqueous dispersion medium at room temperature of 25° C. The concentration is preferably 1% by mass or more and more preferably 3% by mass or more.

As the “cation-modified self-emulsifiable polymer” according to the invention, more specifically, for instance, polyaddition or polycondensation polymer compounds having a cationic group such as primary, secondary or tertiary amino group or a quaternary ammonium group can be cited.

For the above polymers, vinyl polymerization based polymers can be used, such as polymers obtained by the polymerization of the following vinyl monomers. Examples include: acrylic acid esters and methacrylic acid esters (as substituents for the ester group are alkyl and allyl groups, for example, the following groups can be used, methyl, ethyl, n-propyl, isopropyl, n-butyl, sec-butyl, tert-butyl, hexyl, 2-ethylhexyl, tert-octyl, 2-chloroethyl, cyanoethyl, 2-acetoxyethyl, tetrahydrofurfuryl, 5-hydroxypentyl, cyclohexyl, benzyl, hydroxyethyl, 3-methoxybutyl, 2-(2-methoxyethoxy)ethyl, 2,2,2-tetrafuroroethyl, 1H,1H,2H,2H-perfluorodecyl, phenyl, 2,4,4-tetramethyl phenyl, and 4-chlorophenyl);

vinyl esters, specifically aliphatic carboxylic acid vinyl esters which may have a substituent (for example, vinyl acetate, vinyl propionate, vinylbutyrate, vinyl isobutyrate, vinylcaproate, and vinylchloroacetate), aromatic carboxylic acid vinyl esters which may have a substituent (for example, benzoic acid vinyl, 4-methyl benzoic acid vinyl, and salicylic acid vinyl);

acrylamides specifically acryamides, N-monosubstituted acrylamides, N-disubstituted acrylic amides (for substituents there are substitutable groups such as alkyl, aryl, and silyl, for example, methyl, n-propyl, isopropyl, n-butyl, tert-butyl, tert-octyl, cyclohexyl, benzyl, hydroxymethyl, alkoxymethyl, phenyl, 2,4,5-tetramethylphenyl, 4-chlorophenyl, trimethylsilyl);

methacrylamides, specifically methacrylamides, N-monosubstituted methacrylamides, N-disubstituted methacrylamides (for substituents there are substitutable groups such as alkyl, aryl, and silyl, for example, methyl, n-propyl, isopropyl, n-butyl, tert-butyl, tert-octyl, cyclohexyl, benzyl, hydroxymethyl, alkoxymethyl, phenyl, 2,4,5-tetramethylphenyl, 4-chlorophenyl, trimethylsilyl);

olefins (for example ethylene, propylene, 1-pentene, vinyl chloride, vinylidene chloride, isoprene, chloroprene, butadiene), styrenes (for example, styrene, methylstyrene, isopropylstyrene, methoxystyrene, acetoxystyrene, and chlorostyrene), vinyl ethers (for example, methyl vinyl ether, butyl vinyl ether, hexyl vinyl ether, and methoxyethyl vinyl ether).

As the other vinyl monomer, examples include listed crotonate esters, itaconate esters, maleate diesters, fumarate diesters, methyl vinyl ketone, phenyl vinyl ketone, methoxyethyl vinyl ketone, N-vinyloxazolidone, N-vinylpyrrolidone, methylenemalonnitrile, diphenyl-2-acryloyloxyethyl phosphate, diphenyl-2-methacryloyloxyethyl phosphate, dibutyl-2-acryloyloxyethyl phosphate, dioctyl-2-methacryloyloxyethyl phosphate and the like.

As the above-mentioned monomer having a cationic group, there are, for example, monomers having a tertiary amino group, such as dialkylaminoethyl methacrylates, dialkylaminoethyl acrylates and the like.

As polyurethanes applicable to the polymer containing a cationic group, there are, for example, polyurethanes synthesized by the addition polymerization reaction of various combinations of the diol compounds with the diisocyanate compounds listed below.

Examples of the above-mentioned diol compound include ethylene glycol, 1,2-propanediol, 1,3-propanediol, 1,2-butanediol, 1,3-butanediol, 2,3-butanediol, 2,2-dimethyl-1,3-propanediol, 1,2-pentanediol, 1,4-pentanediol, 1,5-pentanediol, 2,4-pentanediol, 3,3-dimethyl-1,2-butanediol, 2-ethyl-2-methyl-1,3-propanediol, 1,2-hexanediol, 1,5-hexanediol, 1,6-hexanediol, 2,5-hexanediol, 2-methyl-2,4-pentanediol, 2,2-diethyl-1,3-propanediol, 2,4-dimethyl-2,4-pentanediol, 1,7-heptanediol, 2-methyl-2-propyl-1,3-propanediol, 2,5-dimethyl-2,5-hexanediol, 2-ethyl-1,3-hexanediol, 1,2-octanediol, 1,8-octanediol, 2,2,4-trimethyl-1,3-pentanediol, 1,4-cyclohexanedimethanol, hydroquinone, diethylene glycol, triethylene glycol, dipropylene glycol, tripropylene glycol, polyethylene glycols (average molecular weight=200, 300, 400, 600, 1000, 1500, or 4000), polypropylene glycols (average molecular weight=200, 400, or 1000), polyester polyols, 4,4′-dihydroxy-diphenyl-2,2-propane, 4,4′-dihydroxyphenylsulfone, and the like.

As the above-mentioned diisocyanate compound, examples include methylene diisocyanate, ethylene diisocyanate, isophorone diisocyanate, hexamethylene diisocyanate, 1,4-cyclohexane diisocyanate, 2,4-toluene diisocyanate, 2,6-toluene diisocyanate, 1,3-xylylene diisocyanate, 1,5-naphthalene diisocyanate, m-phenylene diisocyanate, p-phenylene diisocyanate, 3,3′-dimethyl-4,4′-diphenylmethane diisocyanate, 3,3′-dimethylbiphenylene diisocyanate, 4,4′-biphenylene diisocyanate, dicyclohexylmethane diisocyanate, methylene bis(4-cyclohexyl isocyanate), and the like.

As the cationic group contained in the polyurethane containing a cationic group, there are cationic groups such as primary, secondary and tertiary amines and quaternary ammonium salts. As the self-emulsifiable polymer used for the aqueous dispersion according to the invention, it is preferable to use a urethane resin having cationic groups such as tertiary amines or quaternary ammonium salts. The cationic group-containing polyurethanes can be obtained, for example, by introducing cationic groups into diols such as those described above at the time of synthesizing the polyurethane. Also, in the case of quaternary ammonium salts, polyurethanes containing tertiary amino groups can be quaternized with a quaternizing agent.

The diol compounds and diisocyanate compounds usable for synthesizing the polyurethane may be used each alone, or may be used in combinations of two or more in various proportions decided depending on the purpose (for example, control of the polymer glass transition temperature (Tg), improving solubility, providing compatibility with a binder, and improving stability of a dispersion).

(Mordant)

In the ink receiving layer according to the invention, preferably, with an intention of further improving the image blur resistance over time and water resistance, a mordant such as shown below is added. As the mordant, organic mordants such as cationic polymers (cationic mordants) and inorganic mordants such as water-soluble metal compounds are preferable. As the cationic mordant, polymer mordants having, as a cationic functional group, a primary, secondary or tertiary amino group or a quarternary ammonium salt group can be preferably used. A cationic non-polymer mordant can be used as well.

As the polymer mordant, homopolymers of monomers (mordant monomers) having a primary, secondary or tertiary amino group and salts thereof or a quaternary ammonium salt group, and copolymers or polycondensates between the mordant monomer and other monomer (non-mordant monomer) can be preferably used. Furthermore, the polymer mordants can be used in either form of a water-soluble polymer or aqueous dispersion latex particles.

Examples of the above mordant monomer include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride,

trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, N,N-diethyl-N-methyl- N-2-(4-vinylphenyl)ethylammonium acetate;

quaternary compounds obtained by reacting methyl chlorides, ethyl chlorides, methyl bromides, ethyl bromides, methyl iodides, or ethyl iodides with N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-dimethylaminoethyl (meth)acrylamide, N,N-diethylaminoethyl (meth)acrylamide, N,N-dimethylaminopropyl (meth)acrylamide, or N,N-diethylaminopropyl (meth)acrylamide; and sulfonates, alkyl sulfonates, acetates, or alkyl carboxylates derived from the quaternary compounds by replacement of the anion.

Specific examples of such compounds include monomethyldiallylammonium chloride, trimethyl-2-(methacryloyloxy)ethylammonium chloride, triethyl-2-(methacryloyloxy) ethylammonium chloride, trimethyl-2-(acryloyloxy)ethylammonium chloride, triethyl-2-(acryloyloxy)ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino) ethylammonium chloride, trimethyl-2-(acryloylamino)ethylammonium chloride, triethyl-2-(acryloylamino)ethylammonium chloride, trimethyl-3-(methacryloylamino) propylammonium chloride, triethyl-3-(methacryloylamino)propylammonium chloride, trimethyl-3-(acryloylamino) propylammonium chloride, triethyl-3-(acryloylamino)propylammonium chloride,

N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3- (acryloylamino)propylammonium chloride, trimethyl-2-(methacryloyloxy)ethylammonium bromide, trimethyl-3-(acryloylamino)propylammonium bromide, trimethyl-2-(methacryloyloxy)ethylammonium sulfonate, and trimethyl-3-(acryloylamino)propylammonium acetate.

Examples of other copolymerizable monomers include N-vinylimidazole and N-vinyl-2-methylimidazole. Further, by using a polymerization unit such as N-vinylacetamide, or N-vinylformamide, then forming a vinylamine unit by hydrolysis after the polymerization, and a salt thereof also can be used.

The term “a non-mordant monomer” refers to a monomer that does not have a basic or cationic moiety, such as a primary, secondary or tertiary amino group, a salt thereof, or a quaternary ammonium salt group, and exhibits no or substantially little interaction with dye in inkjet ink.

Examples of non-mordant monomers include alkyl (meth)acrylates; cycloalkyl (meth)acrylates such as cyclohexyl (meth)acrylate; aryl (meth)acrylates such as phenyl (meth)acrylate; aralkyl ester such as benzyl (meth)acrylate; aromatic vinyl compounds such as styrene, vinyltoluene and α-methylstyrene; vinyl esters such as vinyl acetate, vinyl propionate and vinyl versatate; allyl esters such as allyl acetate; halogen-containing monomers such as vinylidene chloride and vinyl chloride; vinyl cyanides such as (meth)acrylonitrile; and olefins such as ethylene and propylene.

The above alkyl (meth)acrylates preferably have 1 to 18 carbon atoms in the alkyl moiety. Examples of such alkyl (meth)acrylates include methyl (meth)acrylate, ethyl (meth)acrylate, propyl (meth)acrylate, isopropyl (meth)acrylate, n-butyl (meth)acrylate, isobutyl (meth)acrylate, tert-butyl (meth)acrylate, hexyl (meth)acrylate, octyl (meth)acrylate, 2-ethylhexyl (meth)acrylate, lauryl (meth)acrylate, and stearyl (meth)acrylate.

Particularly preferred are methyl acrylate, ethyl acrylate, methyl methacrylate, ethyl methacrylate, and hydroxyethyl methacrylate.

One non-mordant monomer may be used alone or two or more non-mordant monomers may be used in combination.

Furthermore, as the polymer mordant, polydiallyldimethylammonium chloride, polymethacryloyloxyethyl-β-hydroxyethyldimethylammonium chloride, polyethyleneimine, polyamide-polyamine resins, cationic starch, dicyandiamide formaline condensates, dimethyl-2-hydroxypropylammonium salt polymers, polyamidine, polyvinylamine, dicyan-based cationic resins represented by dicyandiamide-formaline polycondensates, polyamine-based cationic resins represented by dicyanamide-diethylenetriamine polycondensates, epichlorohydrin-dimethylamine addition polymers, dimethyldiallylammonium chloride-SO₂ copolymers and diallylamine salt-SO₂ copolymers can be preferably cited.

Specific examples of the polymer mordant include those described in JP-A Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134 and 1-161236; U.S. Pat. Nos. 2,484,430, 2,548,564, 3,148,061, 3,309,690, 4,115,124, 4,124,386, 4,193,800, 4,273,853, 4,282,305, and 4,450,224; JP-A Nos. 1-161236, 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, and 2001-301314.

As the inorganic mordant, other than the above, polyvalent water-soluble metal salts and hydrophobic metal salt compounds can be cited. Specific examples of the inorganic mordants include salts and complexes of a metal selected from magnesium, aluminum, calcium, scandium, titanium, vanadium, manganese, iron, nickel, copper, zinc, gallium, germanium, strontium, yttrium, zirconium, molybdenum, indium, barium, lanthanum, cerium, praseodymium, neodymium, samarium, europium, gadolinium, dysprosium, erbium, ytterbium, hafnium, tungsten, and bismuth.

Specific examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, copper (II) chloride, ammonium copper (II) chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminum sulfate, aluminum alum, basic polyaluminum hydroxide, aluminum sulfite, aluminum thiosulfate, polyaluminum chloride, aluminum nitrate nonahydrate, aluminum chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetraisopropyl titanate, titanium acetylacetonate, titanium lactate, zirconium acetylacetonate, zirconyl acetate, zirconyl sulfate, zirconyl ammonium carbonate, zirconyl stearate, zirconyl octylate, zirconyl nitrate, zirconium oxychloride, zirconium hydroxychloride, chromium acetate, chromium sulfate, magnesium sulfate, magnesium chloride hexahydrate, magnesium citrate nonahydrate, sodium phosphotungstate, sodium tungsten citrate, undecatungstophosphoric acid n-hydrate, undecatungstosilicic acid 26-hydrate, molybdenum chloride, undecamolybdophosphoric acid n-hydrate, potassium nitrate, manganese acetate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride and bismuth nitrate. Among these, aluminum-containing compounds, titanium-containing compounds, zirconium-containing compounds and compounds of metals belonging to IIIB group of periodic table (salts or complexes) are preferable.

Furthermore, the “polyvalent metal compounds” cited in the section of (Crosslinking Agent) as well can be preferably used as the mordant.

An amount of the mordant added to the ink receiving layer is preferably in the range of 0.01 g/m² to 5 g/m².

(Other Components)

In addition, the ink receiving layer according to the invention is constructed to contain the following components if necessary.

To restrain the deterioration of the ink colorant, anti-fading agents such as various ultraviolet absorbers, antioxidants and singlet oxygen quenchers may be contained.

Examples of the ultraviolet absorbers include cinnamic acid derivatives, benzophenone derivative and benzotriazolyl phenol derivatives. Specific examples include (butyl α-cyanophenylcinnamate, o-benzotriazole phenol, o-benzotriazole-p-chlorophenol, o-benzotriazole-2,4-di-t-butyl phenol, o-benzotriazole-2,4-di-t-octyl phenol. A hindered phenol compound can be also used as an ultraviolet absorber, and phenols in which at least one of the second position and/or the sixth position is substituted by a branched alkyl group is preferable.

A benzotriazole based ultraviolet absorber, a salicylic acid based ultraviolet absorber, a cyano acrylate based ultraviolet absorber, and an oxalic acid anilide based ultraviolet absorber or the like can be also used. For instance, the ultraviolet absorbers are described in JP-A Nos. 47-10537, 58-111942, 58-212844, 59-19945, 59-46646, 59-109055 and 63-53544, Japanese Patent Application Publication (JP-B) Nos. 36-10466, 42-26187, 48-30492, 48-31255, 48-41572 and 48-54965, 50-10726, U.S. Pat. Nos. 2,719,086, 3,707,375, 3,754,919 and 4,220,711 or the like.

A fluorescent whitening agent can be also used as an ultraviolet absorber, and specific examples include a coumalin based fluorescent whitening agent. Specific examples are described in JP-B Nos. 45-4699 and 54-5324 or the like.

Examples of the antioxidants are described in EP Nos. 223739, 309401, 309402, 310551, 310552 and 459416, D.E. Patent No. 3435443, JP-ANos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 66-88381, 63-113536,

63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-1108437 and 5-170361, JP-B Nos. 48-43295 and 48-33212, U.S. Pat. Nos. 4814262 and 4980275.

Specific examples of the antioxidants include 6-ethoxy-1-phenyl-2,2,4-trimethyl-1,2-dihydroquinoline, 6-ethoxy- 1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4,-tetrahydroquinoline, nickel cyclohexanoate, 2,2-bis(4-hydroxyphenyl)propane, 1,1-bis(4-hydroxyphenyl)-2-ethylhexane, 2-methyl-4-methoxy-diphenylamine, 1-methyl-2-phenyl indole.

These anti-fading agents can be used singly or in a combination of two or more of them. The anti-fading agents can be dissolved in water, dispersed, emulsified, or they can be included in microcapsules. The amount of the anti-fading agents added is preferably 0.01% by mass to 10% by mass, relative to the total mass of the coating solution for the ink receiving layer.

In the invention, in order to prevent curl, it is preferable to include organic solvents with a high boiling point in the ink receiving layer. For the high boiling point organic solvents, water-soluble ones are preferable. As water-soluble organic solvents with high boiling points, the following alcohols are examples: ethylene glycol, propylene glycol, diethylene glycol, triethylene glycol, glycerin, diethylene glycol monobutylether (DEGMBE), triethylene glycol monobutyl ether, glycerin monomethyl ether, 1,2,3-butanetriol, 1,2,4-butanetriol, 1,2,4-pentanetriol, 1,2,6-hexanetriol, thiodiglycol, triethanolamine, polyethylene glycol (average molecular weight of 400 or less). Diethylene glycol monobutylether (DEGMBE) is preferable.

The amount of the above high boiling point organic solvents used in the coating solution for the ink receiving layer is preferably 0.05% by mass to 1% by mass, and particularly preferably 0.1% by mass to 0.6% by mass. The ink receiving layer may contain various inorganic salts and acids and alkalis as a pH controlling agent for the purpose of enhancing dispersibility of inorganic fine particles.

Furthermore, from the viewpoints of suppressing frictional electrification and peeling electrification of the ink receiving layer, metal oxide fine particles having electron conductivity may be contained in the ink receiving layer. And from the viewpoint of reducing a frictional property of the surface, various matting agents may be contained in the ink receiving layer.

(Support)

As the support that is used in the invention, any one of a transparent support made of a transparent material such as plastics and a non-transparent support made of a non-transparent material such as paper can be used. However, as the outermost layer on a side of a support made of a non-transparent material such as paper where an ink receiving layer is disposed, a resin layer including a thermoplastic resin such as polyethylene (hereinafter, in some cases, simply referred to as “thermoplastic resin-containing layer”) is preferably disposed. This thermoplastic resin-containing layer can be disposed as needs arise on both sides of paper or the like.

In the next place, thermoplastic resin will be described.

The thermoplastic resin is not limited to particular one and one obtained by microparticulating a known thermoplastic resin such as a polyolefin resin (for instance, a homopolymer of α-olefin such as polyethylene, polypropylene or a mixture thereof) or a latex thereof can be appropriately selected to use. Among these, as thermoplastic resin, a polyolefin resin is preferable (particularly, polyethylene resin).

The polyolefin resin, as far as it can be extrusion-coated, is not limited in the molecular weight thereof, and the molecular weight can be appropriately selected according to the purpose. Normally, a polyolefin resin having a molecular weight in the range of 20,000 to 200,000 is used.

As for the polyethylene resin, there is no particular limitation. For instance, high-density polyethylene (HDPE), low-density polyethylene (LDPE) and linear low-density polyethylene (L-LDPE) can be cited.

In thermoplastic resin-containing layer, a white pigment, a colored pigment or a fluorescent whitening agent, or stabilizers such as phenol, bisphenol, thiobisphenol, amines, benzophenone, salicylate, benzotriazole and organometallic compounds can be preferably added.

As a method of forming thermoplastic resin-containing layer, melt-extrusion, wet-lamination and dry lamination methods can be cited, and the melt-extrusion method is the most preferable one. When a thermoplastic resin-containing layer is formed by means of the melt extrusion, in order to strengthen the adhesion between a thermoplastic resin-containing layer and a lower layer thereof (hereinafter, referred to as coated layer), a surface of the coated layer is preferably pre-treated.

As the pre-treatment, acid etching with a sulfuric acid-chromic acid mixture, flame processing with a gas flame, UV-irradiation treatment, corona discharge treatment, glow discharge treatment and anchor coating of alkyl titanate can be cited, and an appropriate one can be selected therefrom to use. In particular, from the viewpoint of conveniences, the corona discharge treatment is preferable. When the corona discharge treatment is applied, the pre-treatment is necessarily applied so that a contact angle with water may be 70° or less.

—Paper Base Material—

In the support in the invention, a paper base material that is a non-transparent support can be used.

The paper base material may be a natural pulp paper containing a common natural pulp as a main component; a mixed paper containing a natural pulp and a synthetic fiber; a synthetic fiber paper containing a synthetic fiber as a main component; or a simulated paper, which is produced from a synthetic resin film of such as polystyrene, polyethylene terephthalate or polypropylene. Natural pulp papers (hereinafter, referred to simply as the “base paper”) are particularly preferable. The base paper may be a neutral paper (pH: 5 to 9) or an acidic paper, but is preferably a neutral paper.

As the base paper, one which has as the primary raw material natural pulp selected from conifers and broad leaf trees and to which, as needs arise, a loading material such as clay, talc, calcium carbonate, or urea resin fine particles; a sizing agent such as rosin, an alkyl ketene dimer, a higher fatty acid, epoxidized fatty acid amide, paraffin wax, or alkenyl succinate; a paper strength intensifying agent such as starch, polyamide polyamine epichlorohydrin, or polyacrylamide; and a fixing agent such as aluminum sulfate or a cationic polymer are added can be used. Furthermore, a softening agent such as a surfactant may be added thereto. Still furthermore, synthetic paper that uses synthetic pulp instead of the natural pulp may be used, or a mixture of natural pulp and synthetic pulp in an arbitrary ratio may be used. Among these, broad leaf tree pulp of short fiber and high smoothness is preferably used. The hydrature of pulp material to be used is preferably in the range of 200 mL to 500 mL (C.S.F.), and more preferably in the range of 300 mL to 400 mL.

The paper base material may contain other ingredients such as a sizing agent, softening agent, paper strength additive, and fixing agent. The sizing agents include rosins, paraffin waxes, higher aliphatic acid salts, alkenyl succinate, aliphatic acid anhydrides, styrene-maleic anhydride copolymers, alkyl ketene dimers and epoxidized aliphatic acid amides. The softening agents include reaction products from maleic anhydride copolymers and polyalkylene polyamines and higher aliphatic acid quaternary ammonium salts. The paper strength additives include polyacrylamide, starch, polyvinyl alcohol, melamine-formaldehyde condensates and gelatin. The fixing agents include aluminum sulfate and polyamide polyamine epichlorohydrins. Additionally, as needs arise, a dye, fluorescent dye or anti-static agent may be added.

The aforementioned paper base material is preferably subjected, prior to the formation of thermoplastic resin-containing layer, to an activation treatment such as corona discharge treatment, flame treatment, glow discharge treatment or plasma treatment.

—Calender Process—

The support according to the invention can be subjected to a calender treatment.

When after a thermoplastic resin-containing layer is disposed on the paper base material, a calender treatment is applied under specific conditions, the planarity of thermoplastic resin-containing layer can be obtained, and high glossiness, high planarity and high quality image forming property of a surface of an ink receiving layer formed through thermoplastic resin-containing layer can be secured.

The calender treatment is preferably applied in such a manner that, with a soft calender or super calender at least one of a pair of rolls of which is constituted of a metal roll (preferably constituted of a metal roll and a resin roll) or both thereof, a surface temperature of the metal roll is set to a temperature equal to or higher than the glass transition temperature of thermoplastic resin and the nip pressure between a roll nip of the pair of rolls is set to 50 kg/cm to 400 kg/cm.

In what follows, a soft calender and a super calender, both having a metal roll and a resin roll, will be detailed. The metal roll, as long as it is a cylindrical or columnar roll having a smooth surface and has a heating unit inside thereof, is not particularly limited in a material, that is, a known metal roll can be appropriately selected to use. Furthermore, the metal roll is preferably as smooth as possible in the surface roughness since the metal roll comes into contact with a recording surface side of surfaces on both sides of the support in the calender treatment, that is, a surface on a side where the ink receiving layer described below is formed. The surface roughness is specifically preferably 0.3 s or less in terms of the surface roughness stipulated by JIS B0601, and more preferably 0.2 s or less.

Furthermore, a surface temperature of the metal roll during the treatment is generally preferably in the range of 70° C. to 250° C. when the paper base material is treated. On the other hand, when the paper base material on which thermoplastic resin layer is coated is treated, the surface temperature is preferably equal to or higher than the glass transition temperature Tg of thermoplastic resin contained in thermoplastic resin-containing layer, and more preferably the Tg or higher and Tg+40° C. or lower.

The resin roll may be appropriately selected from a synthetic resin roll made of a polyurethane resin or a polyamide resin, and the shore D hardness is suitably from 60 to 90.

The nip pressure of the pair of rolls having the metal roll is appropriately from 50 kg/cm to 400 kg/cm, and preferably from 100 kg/cm to 300 kg/cm. The treatment is desirably carried out substantially once or twice when a soft calender and/or super calender that is provided with a pair of rolls that are constituted as described above is used.

A support used for an inkjet recording medium of the invention is not particularly limited; that is, a transparent support made of a transparent material such as plastics can be used as well. As a material capable of being used in the transparent support, a material that is transparent and has the nature capable of withstanding radiation heat when used in OHP and backlight display is preferable. As such a material, for instance, polyesters such as polyethylene terephthalate (PET), polysulfone, polyphenylene oxide, polyimide, polycarbonate and polyamide can be cited. Among these, polyesters are preferable; in particular, polyethylene terephthalate is preferable.

Furthermore, with a read only optical disk such as CD-ROM or DVD-ROM, a write once optical disk such as CD-R or DVD-R or a rewritable optical disk as a support, an ink receiving layer and a gloss imparting layer can be imparted as well on a the label surface side.

To the layers (e.g., ink receiving layer) forming the inkjet recording medium of the invention, a polymer fine particle dispersion may be added. The polymer fine particle dispersion is used for the purpose of improving film physical properties, such as dimension stabilization, curl inhibition, adhesion inhibition, or inhibition of film cracking. The polymer fine particle dispersion is described in each of JP-A Nos. 62-245258, 62-1316648, and 62-110066. When a polymer fine particle dispersion having a low glass transition temperature (40° C. or lower) is added to the ink receiving layer, cracking or curling of the layer can be prevented. Even when a polymer fine particle dispersion having a high glass transition temperature is added to a back layer, curling can be prevented.

The thickness of the ink receiving layer of the invention needs to be determined in connection with the porosity of the layer, because the layer needs to have an absorption capacity allowing adsorption of all droplets in the case of inkjet recording. For example, when the ink amount is 8 nL/mm² and the porosity is 60%, a film having a thickness of about 15 μm or more is required. Considering this respect, in the case of inkjet recording, the thickness of the ink receiving layer is preferably 10 μm to 50 μm.

The diameter of a fine pore of the ink receiving layer is preferably 0.005 μm to 0.030 μm and more preferably 0.01 μm to 0.025 μm, in terms of median size. The porosity and the fine pore median size can be measured using a mercury porosimeter (trade name: PORE SIZER 9320-PC2, manufactured by Shimadzu Corporation).

The ink receiving layer is preferably higher in transparency, and the haze value, an indicator of transparency, of the ink receiving layer formed on a transparent film support is preferably 30% or less and more preferably 20% or less. The haze value may be determined by using a hazemeter (trade name: HGM-2DP, manufactured by Suga Test Instrument Co., Ltd.).

—Inkjet Recording Method—

In the inkjet recording method of the invention, an inkjet recording system is not limited, and known systems, such as an electric charge control system including discharging (ejecting) ink utilizing an electrostatic attraction force, a drop on demand system (pressure pulse system) utilizing vibration pressure of a piezo-electric element, an acoustic inkjet system including changing an electrical signal into an acoustic beam, irradiating ink with the acoustic beam, and discharging the ink utilizing radiation pressure, or a thermal inkjet system including heating ink to form bubbles, and utilizing the generated pressure, is used. The inkjet recording system includes a system of ejecting a large number of inks having a low concentration, referred to as photo ink, with a small volume, a system of improving image quality using a plurality of inks having substantially the same hue and different concentrations, or a system using colorless transparent ink.

(Drying Process)

In the inkjet recording method of the invention, it is preferable to perform drying after image printing (preferably within 10 minutes after image printing). A drying device is provided in an inkjet recording apparatus in an in-line or off-line manner. As a heating method, general methods, such as warm air or hot air heating using a hot air ventilation dryer, infrared drying using an infrared lamp, hot roll heating, or induction heating, are performed. In order to obtain a recorded image excellent in density and suppressing changes in hue from the hue obtained immediately after image printing without causing a problem of, for example, curling due to overheating, the heating treatment is preferably performed within 1 minute immediately after image printing and the drying is preferably performed at 50° C. to 200° C. for 1 second to 5 minutes.

### EXAMPLES

In what follows, the invention will be detailed with reference to examples. However, the invention is not limited to the examples. In the examples, word “parts” and symbol “%”, respectively, mean “parts by mass” and “% by mass”.

### Example 1

### Production of Non-Water Absorbing Support

50 parts of LBKP formed of acacia and 50 parts of LBKP formed of aspen were individually refined to 300 mL of Canadian freeness using a disc refiner, thereby preparing pulp slurry.

To the pulp slurry obtained above, 1.3% of cation modified starch (trade name: CAT0304L, manufactured by Nippon NSC Ltd.), 0.15% of anionic polyacrylamide (trade name: POLYACRON ST-13, manufactured by Seiko Chemicals, Co., Ltd.), 0.29% of alkyl ketene dimer (trade name: SIZE PINE K, manufactured by Arakawa Chemical Industries, Ltd.), 0.29% of epoxidized behenic acid amide, and 0.32% of polyamide polyamine epichlorohydrin (trade name: ARAFIX 100, manufactured by Arakawa Chemical Industries, Ltd.), with respect to pulp, were added, and then 0.12% of defoaming agent was added.

In a process of forming the pulp slurry prepared as described above into paper using a Fortlinear paper machine, pressing a felt side of a web against a drum dryer cylinder through a dryer canvas, and drying, the drying was performed while the tensile strength of the dryer canvas was adjusted to 1.6 kg/cm, then 1 g/m² of polyvinyl alcohol (trade name: KL-118, manufactured by Kuraray) was applied to both sides of a base paper using a size press and dried, and then calender treatment was performed. Paper making was performed at a basis weight of the base paper of 166 g/m² to obtain a 160 μm thick of base paper.

Corona discharge treatment was performed to the wire surface side of the obtained base paper, and then high density polyethylene was coated using a molten extruder so that the thickness was 25 μm, thereby forming a thermoplastic resin layer with a mat surface (hereinafter, the thermoplastic resin layer side being referred to as a “rear surface”). Corona discharge treatment was further performed to the thermoplastic resin layer on the rear surface side, and then a dispersion liquid, in which aluminum oxide (trade name: ALUMINASIL 100, manufactured by Nissan Chemical Industries, Ltd.) and silicon dioxide (trade name: “SNOWTEX O”, manufactured by Nissan Chemical Industries, Ltd.), as antistatic agents, were dispersed in water at a mass ratio of 1:2 was applied so that the dry mass was 0.2 g/m².

Furthermore, corona discharge treatment was performed to the felt surface side of the base paper on which the thermoplastic resin layer was not provided. Thereafter, low density polyethylene having a MFR (melt flow rate) of 3.8 was prepared so that the content of anatase titanium dioxide was 10%, and the content of ultramarine blue manufactured by Tokyo Ink Co., Ltd. was 0.3% and the content of “WHITEFLOUR PSN CONC” (trade name) as a fluorescent whitening agent manufactured by Nippon Chemical Industrial Co., LTD. was 0.08%. The obtained low density polyethylene was extruded using a molten extruder so that the thickness was 25 μm, thereby forming a thermoplastic resin layer having high glossiness on the felt surface side of the base paper (hereinafter, the surface on which the thermoplastic resin layer having high glossiness was formed being referred to as a “front surface”).

<Preparation of Coating Solution A1 for Ink Receiving Layer>

(1) AEROSIL300SV (trade name, inorganic fine particles), (2) ion exchanged water, and (3) SHALLOL DC-902P (trade name, dispersant) shown in the following composition A1 were mixed, the mixture was dispersed using an ultrasonic disperser [manufactured by SMT Co., Ltd.] to form a dispersion liquid, and then the dispersion was heated to 45° C. and held for 20 hours. Thereafter, (4) boric acid, (5) GOSEFIMER Z200 (trade name, specific water-soluble resin), and (6) EMULGEN 109P (trade name, manufactured by Kao Corporation) were added to the dispersion at 30° C., thereby preparing a coating solution A1 for ink receiving layer.

### —Composition A1 of Coating Solution A1 for Ink Receiving Layer—

| | | | |
|---|---|---|---|
| (1) | AEROSIL300SV | 10.0 | parts |
| | [trade name, manufactured by Nippon Aerosil Co. | | |
| | Ltd.; vapor-phase process silica fine particles | | |
| | (inorganic fine particles)] | | |
| (2) | Ion exchanged water | 56 | parts |
| (3) | SHALLOL DC-902P (51.5% aqueous solution) | 0.8 | parts |
| | [trade name, manufactured by Dai-Ichi Kogyo Seiyaku | | |
| | Co., Ltd.; dispersant] | | |
| (4) | Boric acid (crosslinking agent) | 0.37 | parts |
| (5) | GOSEFIMER Z200 (7% aqueous solution) | 29 | parts |
| | [trade name, manufactured by Nippon Synthetic | | |
| | Chemical Industry Co., Ltd.; acetoacetyl modified | | |
| | polyvinyl alcohol; number average degree of | | |
| | polymerization: about 1100, saponification degree: | | |
| | 98 mol %] | | |
| (6) | EMULGEN 109P (10% aqueous solution) | 0.6 | parts |
| | [trade name, manufactured by Kao Corporation; | | |
| | surfactant] | | |

### <Preparation of Crosslinking Agent Solution B1>

According to the composition B1 shown below, (1) ion exchanged water, (2) crosslinking agent, (3) pH adjustor, and (4) EMULGEN 109P were dissolved at ordinary temperature, thereby preparing a crosslinking agent solution B1.

### —Composition B1—

| | | | |
|---|---|---|---|
| (1) | Ion exchanged water | 30 | parts |
| (2) | Crosslinking agent (adipic acid dihydrazide; ADH) | 1 | part |
| (3) | pH adjustor (ammonium carbonate) | 1 | part |
| (4) | EMULGEN 109P (10% aqueous solution) | 0.5 | parts |
| | [trade name, manufactured by Kao Corporation; | | |
| | surfactant] | | |

(Production of Inkjet Recording Medium)

Corona discharge treatment was performed to the front surface of the support, the coating solution A1 for ink receiving layer was applied using a slide bead coater so that the thickness was 200 mL/m², and the resulting coating layer was dried at 80° C. (air velocity of 3 m/second) for 3 minutes using a hot air dryer. In this period, the coating layer exhibited constant rate drying. Thereafter, the coating layer was immersed in the crosslinking agent solution B1 for 1 second immediately after drying for 3 minutes, 15 g/m² of the crosslinking agent solution B1 was adhered onto the coating layer, and then further dried at 80° C. for 10 minutes.

Thus, an inkjet recording medium 1 which has an ink receiving layer having a dry thickness of 35 μm was produced.

<Production of Ink>

Deionized water was added to a component having the following composition C1 to reach 1 L, and then the resultant was stirred for 1 hour while heating at 30° C. to 40° C. Thereafter, the pH was adjusted to 9 using 10 mol/L KOH, and filtration under reduced pressure was performed using a micro filter having an average pore diameter of 0.25 μm, thereby preparing a magenta ink (M-101).

### —Composition C1—

| | | |
|---|---|---|
| Dye M-1 (shown below) | 35.0 | g/L |
| Glycerol | 102.0 | g/L |
| Triethylene glycol | 19.0 | g/L |
| Ethylene glycol monomethyl ether (EGMME) | 100.0 | g/L |
| 2-Pyrrolidone | 11.0 | g/L |
| Urea | 24.0 | g/L |
| PROXEL XL2 [trade name, manufactured by AVECIA] | 1.1 | g/L |
| Betaine compound C (shown below) | 17.0 | g/L |

Dye M-1

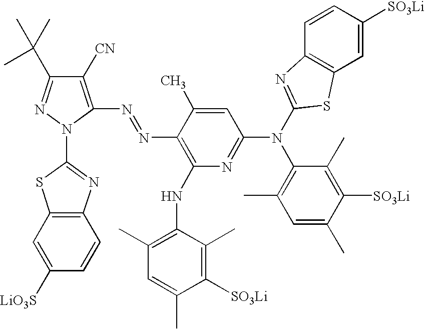

Betaine compound C

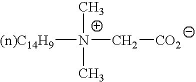

### <Image Recording and Performance Evaluation>

### (Image Recording)

A magenta solid image was printed using the magenta ink (M-101) obtained above onto the side, on which the ink receiving layer was formed, of the inkjet recording medium 1 obtained above using a printer A820 manufactured by Seiko Epson under an environment of 25° C. and 50% RH, while setting the color adjustment to no color correction, and then stored for 24 hours in the same environment.

### (Coloring Density)

After storing, the density was measured using X-rite 310 (trade name, manufactured by X-Rite Inc.), and was evaluated in accordance with the following evaluation criteria. The obtained results are shown in Table 1 described below.

### —Evaluation Criteria—

A: Density is 2.4 or more
B: Density is 2.3 or more and lower than 2.4
C: Density is 2.2 or more and lower than 2.3
D: Density is lower than 2.2
   (Changes in Hue from Hue Obtained Immediately After Image Printing)

A magenta solid image was printed by discharging the magenta ink (M-101) onto the side, on which the ink receiving layer was formed, of the inkjet recording medium 1 obtained above using a printer A820 (trade name, manufactured by Seiko Epson) under an environment of 23° C. and 50% RH.

Immediately after printing (within 2 minutes after printing) and after 24 hours had passed after printing, the hue of the magenta solid portion was measured, and a difference between the hue immediately after printing and the hue after 24 hours had passed after printing was defined as a hue difference (ΔE).

Here, the hue was determined by determining L*a*b* under the conditions of a light source F8 and a viewing angle of 2° using a spectrophotometer (trade name: SPECTROLINO, manufactured by GretagMacbeth AG.).

Based on the obtained hue difference (ΔE), changes in color tone were evaluated according to the following evaluation criteria. The obtained results are shown in Table 1 described below.

### —Evaluation Criteria—

A: ΔE<1; Changes in hue are hardly recognized.
B: 1<ΔE<2; Changes in hue are recognized but are not noticeable.
C: 2≦ΔE<4; Changes in hue are considerably noticeable.
D: 4≦ΔE; Changes in hue are noticeable, causing problems.

### Examples 2 to 15, Comparative Examples 4 and 5

A magenta ink was prepared in a manner substantially similar to that in Example 1 except that ethylene glycol monomethyl ether (EGMME) of the composition C1 was replaced by a water-soluble organic solvent shown in Table 1 described below in the preparation of the magenta ink (M-101). Then, evaluation was performed in a manner substantially similar to that in Example 1 using the inkjet recording medium 1. The obtained results are shown in Table 1 described below.

### Examples 16 to 23

A magenta ink was prepared in a manner substantially similar to that in Example 1 except ethylene glycol monomethyl ether (EGMME) of the composition C1 was replaced by a water-soluble organic solvent shown in Table 1 described below in the preparation of the magenta ink (M-101). Then, inkjet recording (image printing) was performed using the inkjet recording medium 1. Image printing was performed in a manner substantially similar to that in Example 1 except that the inkjet recording medium after 5 seconds from the image printing was subjected to drying (drying process) at 80° C. for one minute using a hot air dryer (trade name: TSK-60, manufactured by TAKETSUNA MANUFACTORY CO., LTD.), and then evaluation was performed in a manner substantially similar to that in Example 1. The obtained results are shown in Table 1 described below.

### Example 24

An inkjet recording medium 2 was produced in a manner substantially similar to that in the production of the inkjet recording medium 1, except that a crosslinking agent solution B2 of the following composition B2 was used in place of the crosslinking agent solution B1 in the production of the inkjet recording medium 1.

### —Composition B2 of Crosslinking Agent Solution B2—

| | | | |
|---|---|---|---|
| (1) | Ion exchanged water | 30 | parts |
| (2) | Crosslinking agent (zirconyl ammonium carbonate) | 2 | parts |
| | [trade name: ZIRCOSOL AC-7 (28% aqueous solution), | | |
| | manufactured by Daiichi Kigenso Kagaku Kogyo Co., | | |
| | Ltd.] | | |
| (3) | pH adjustor (ammonium carbonate) | 1 | part |
| (4) | EMULGEN 109P (10% aqueous solution) | 0.5 | parts |
| | [trade name, manufactured by Kao Corporation; | | |
| | surfactant] | | |

An image was printed in a manner substantially similar to that in Example 22 except that the inkjet recording medium 1 was replaced by the inkjet recording medium 2, and evaluation was performed in a manner substantially similar to that in Example 22. The obtained results are shown in Table 1 described below.

The coating amount of the crosslinking agent solution B2 adhered onto the coating layer of the coating solution A1 for ink receiving layer was 15 g/m². The dry film thickness of the ink receiving layer of the inkjet recording medium 2 was 35 μm.

### Example 25

An inkjet recording medium 3 was produced in a manner substantially similar to that in the production of the inkjet recording medium 1, except that a coating solution A2 for ink receiving layer of the following composition A2 in place of the coating solution Al for ink receiving layer and a coating solution B3 of the following composition B3 was used in place of the crosslinking agent solution B1 in the production of the inkjet recording medium 1.

—Composition A2 of Coating Solution A2 for Ink Receiving Layer—

| | | | |
|---|---|---|---|
| (1) | AEROSIL300SV | 10.0 | parts |
| | [trade name, manufactured by Nippon Aerosil Co.; | | |
| | Vapor-phase process silica fine particles (inorganic | | |
| | fine particles)] | | |
| (2) | Ion exchanged water | 56 | parts |
| (3) | SHALLOL DC-902P (51.5% aqueous solution) | 0.8 | parts |
| | [trade name, manufactured by Dai-Ichi Kogyo Seiyaku | | |
| | Co., Ltd.; dispersant] | | |
| (4) | ZA-30 (zirconyl acetate) | 0.5 | parts |
| | [trade name, manufactured by Daiichi Kigenso Kagaku | | |
| | Kogyo Co., Ltd.; crosslinking agent] | | |
| (5) | GOSEFIMER Z200 (7% aqueous solution) | 29 | parts |
| | [trade name, manufactured by Nippon Synthetic | | |
| | Chemical Industry Co., Ltd.; acetoacetyl modified | | |
| | polyvinyl alcohol, number average degree of | | |
| | polymerization: 1100, saponification degree: | | |
| | 98 mol %] | | |
| (6) | Boric acid (crosslinking agent) | 0.37 | parts |
| (7) | EMULGEN 109P (10% aqueous solution) | 0.6 | parts |
| | [trade name, manufactured by Kao Corporation; | | |
| | surfactant] | | |

—Composition B3 of Coating Solution B3—

| | | | |
|---|---|---|---|
| (1) | Ion exchanged water | 32 | parts |
| (2) | pH adjustor (ammonium carbonate) | 1 | part |
| (3) | EMULGEN 109P (10% aqueous solution) | 0.5 | parts |
| | [trade name, manufactured by Kao Corporation; | | |
| | surfactant] | | |

Image printing was performed in a manner substantially similar to that in Example 22 except that the inkjet recording medium 1 was replaced by the inkjet recording medium 3, and evaluation was performed in a manner substantially similar to that in Example 22. The obtained results are shown in Table 1 described below.

The coating amount of the coating solution B3 adhered onto the coating layer of the coating solution A2 for ink receiving layer was 15 g/m². The dry film thickness of the ink receiving layer of the inkjet recording medium 3 was 35 μm.

### Comparative Example 1

A magenta ink (M-102) was prepared in a manner substantially similar to that in the preparation of the magenta ink (M-101) except that the composition C1 was changed to the following composition C2 in the preparation of the magenta ink (M-101).

### —Composition C2—

| | | |
|---|---|---|
| Dye M-1 (mentioned above) | 35.0 | g/L |
| Glycerol | 123.0 | g/L |
| Triethylene glycol | 23.0 | g/L |
| Ethylene glycol monomethyl ether (EGMME) | 70 | g/L |
| 2-Pyrrolidone | 14.0 | g/L |
| Urea | 24.0 | g/L |
| PROXEL XL2 [trade name, manufactured by AVECIA] | 1.1 | g/L |
| Betaine compound C (mentioned above) | 17.0 | g/L |

An image was printed on the inkjet recording medium 1 in a manner substantially similar to that in Example 1 except using the magenta ink (M-102), and evaluation was performed in a manner substantially similar to that in Example 1. The obtained results are shown in Table 1 described below.

### Comparative Example 2

A magenta ink was prepared in a manner substantially similar to that in Comparative Example 1 except that ethylene glycol monomethyl ether (EGMME) of the composition C2 was replaced by a water-soluble organic solvent shown in Table 1 described below in the preparation of the magenta ink (M-102). Then, inkjet recording (image printing) was performed using the inkjet recording medium 1, and evaluation was performed in a manner substantially similar to that in Example 1. The obtained results are shown in Table 1 described below.

### Comparative Example 3

A magenta ink (M-103) was prepared in a manner substantially similar to that in the preparation of the magenta ink (M-101) except that the composition C1 was changed to the following composition C3 in the preparation of the magenta ink (M-101).

### —Composition C3—

| | |
|---|---|
| Dye M-1 (mentioned above) | 35.0 g/L |
| Glycerol | 114.0 g/L |
| Triethylene glycol | 22.0 g/L |
| Ethylene glycol monomethyl ether (EGMME) | 81.0 g/L |
| 2-Pyrrolidone | 13.0 g/L |
| Urea | 24.0 g/L |
| PROXEL XL2 [trade name, manufactured by AVECIA] | 1.1 g/L |
| Betaine compound C (mentioned above) | 17.0 g/L |

An image was printed on the inkjet recording medium 1 in a manner substantially similar to that in Example 1 except using the magenta ink (M-103), and evaluation was performed in a manner substantially similar to that in Example 1. The obtained results are shown in Table 1 described below.

### Comparative Example 6

An inkjet recording medium 4 was produced in a manner substantially similar to that in the production of the inkjet recording medium 1 except that a coating solution A3 for ink receiving layer of the following composition A3 was used in place of the coating solution Al for ink receiving layer in the production of the inkjet recording medium 1.

### —Composition A3 of Coating Solution A3 for Ink Receiving Layer—

| | | | |
|---|---|---|---|
| (1) | AEROSIL300SV | 10.0 | parts |
| | [trade name, manufactured by Nippon Aerosil Co.; | | |
| | vapor-phase process silica fine particles (inorganic | | |
| | fine particles)] | | |
| (2) | Ion exchanged water | 56 | parts |
| (3) | SHALLOL DC-902P (51.5% aqueous solution) | 0.8 | parts |
| | [trade name, manufactured by Dai-Ichi Kogyo Seiyaku | | |
| | Co., Ltd.; dispersant] | | |
| (4) | Boric acid (crosslinking agent) | 0.37 | parts |
| (5) | NM-11 | 29 | parts |
| | [trade name, manufactured by Nippon Synthetic | | |
| | Chemical Industry Co., Ltd.; general polyvinyl | | |
| | alcohol, number average degree of polymerization: | | |
| | 1100, saponification degree: 99 mol %] | | |
| (6) | EMULGEN 109P (10% aqueous solution) | 0.6 | parts |
| | [trade name, manufactured by Kao Corporation; | | |
| | surfactant] | | |

The coating amount of the crosslinking agent solution B1 adhered onto the coating layer of the coating solution A3 for the ink receiving layer was 15 g/m². The dry film thickness of the ink receiving layer of the inkjet recording medium 4 was 35 82 m.

An image was printed in a manner substantially similar to that in Example 1 except that the inkjet recording medium 1 was replaced by the inkjet recording medium 4, and evaluation was performed in a manner substantially similar to that in Example 1. The obtained results are shown in Table 1 described below.

### Comparative Example 7

A magenta ink was prepared in a manner substantially similar to that in the preparation of the magenta ink (M-101) except that ethylene glycol monomethyl ether (EGMME) of the composition C1 was replaced by a water-soluble organic solvent shown in Table 1 described below in the preparation of the magenta ink (M-101). An image was printed on the inkjet recording medium 4 in a manner substantially similar to that in Comparative Example 6 except using the resulting magenta ink. Then, evaluation was performed in a manner substantially similar to that in Example 1. The obtained results are shown in the following Table 1.

TABLE 1

| | | | | | Crosslinking agent | | | | |
|---|---|---|---|---|---|---|---|---|---|
| | | Ink | | | | Cross- | | | |
| | | | Solvent | Ink receiving | | linking | | Evaluation result | |
| | | Water-soluble | ratio | layer | Coating | agent | Drying | Coloring | Hue |
| | | organic solvent | (%) | PVA type | solution A | solution B | process | density | change |
| Examples | 1 | EGMME | 43 | Acetoacetyl | Boric acid | ADH | None | A | B |
| | | | | modified PVA | | | | | |
| | 2 | DEGMME | 43 | Acetoacetyl | Boric acid | ADH | None | A | B |
| | | | | modified PVA | | | | | |
| | 3 | DEGMBE | 43 | Acetoacetyl | Boric acid | ADH | None | A | B |
| | | | | modified PVA | | | | | |
| | 4 | DEGMEE | 43 | Acetoacetyl | Boric acid | ADH | None | A | B |
| | | | | modified PVA | | | | | |
| | 5 | PGMME | 43 | Acetoacetyl | Boric acid | ADH | None | A | B |
| | | | | modified PVA | | | | | |
| | 6 | DPGMME | 43 | Acetoacetyl | Boric acid | ADH | None | A | B |
| | | | | modified PVA | | | | | |
| | 7 | DPGMBE | 43 | Acetoacetyl | Boric acid | ADH | None | A | B |
| | | | | modified PVA | | | | | |
| | 8 | DEGDME | 43 | Acetoacetyl | Boric acid | ADH | None | A | B |
| | | | | modified PVA | | | | | |
| | 9 | EGDME | 43 | Acetoacetyl | Boric acid | ADH | None | A | B |
| | | | | modified PVA | | | | | |
| | 10 | 1,2-hexanediol | 43 | Acetoacetyl | Boric acid | ADH | None | A | B |
| | | | | modified PVA | | | | | |
| | 11 | 1,2-pentanediol | 43 | Acetoacetyl | Boric acid | ADH | None | A | B |
| | | | | modified PVA | | | | | |
| | 12 | 1,2-butanediol | 43 | Acetoacetyl | Boric acid | ADH | None | A | B |
| | | | | modified PVA | | | | | |
| | 13 | 1,2-propanediol | 43 | Acetoacetyl | Boric acid | ADH | None | A | B |
| | | | | modified PVA | | | | | |
| | 14 | Ethylene glycol | 43 | Acetoacetyl | Boric acid | ADH | None | A | B |
| | | | | modified PVA | | | | | |
| | 15 | 2-methyl- | 43 | Acetoacetyl | Boric acid | ADH | None | A | B |
| | | pentane-2,4- | | modified PVA | | | | | |
| | | diol | | | | | | | |
| | 16 | EGMME | 43 | Acetoacetyl | Boric acid | ADH | Done | A | A |
| | | | | modified PVA | | | | | |
| | 17 | DEGMME | 43 | Acetoacetyl | Boric acid | ADH | Done | A | A |
| | | | | modified PVA | | | | | |
| | 18 | DEGMBE | 43 | Acetoacetyl | Boric acid | ADH | Done | A | A |
| | | | | modified PVA | | | | | |
| | 19 | 1,2-hexanediol | 43 | Acetoacetyl | Boric acid | ADH | Done | A | A |
| | | | | modified PVA | | | | | |
| | 20 | 1,2-pentanediol | 43 | Acetoacetyl | Boric acid | ADH | Done | A | A |
| | | | | modified PVA | | | | | |
| | 21 | 1,2-butanediol | 43 | Acetoacetyl | Boric acid | ADH | Done | A | A |
| | | | | modified PVA | | | | | |
| | 22 | 1,2-propanediol | 43 | Acetoacetyl | Boric acid | ADH | Done | A | A |
| | | | | modified PVA | | | | | |
| | 23 | TEGDME | 43 | Acetoacetyl | Boric acid | ADH | Done | A | A |
| | | | | modified PVA | | | | | |
| | 24 | 1,2-propanediol | 43 | Acetoacetyl | Boric acid | AC-7 | Done | B | A |
| | | | | modified PVA | | | | | |
| | 25 | 1,2-propanediol | 43 | Acetoacetyl | Boric acid | None | Done | B | A |
| | | | | modified PVA | ZA-30 | | | | |
| Comparative | 1 | EGMME | 30 | Acetoacetyl | Boric acid | ADH | None | C | C |
| Examples | | | | modified PVA | | | | | |
| | 2 | DEGMME | 30 | Acetoacetyl | Boric acid | ADH | None | C | C |
| | | | | modified PVA | | | | | |
| | 3 | EGMME | 35 | Acetoacetyl | Boric acid | ADH | None | C | B |
| | | | | modified PVA | | | | | |
| | 4 | TEGMME | 43 | Acetoacetyl | Boric acid | ADH | None | C | C |
| | | | | modified PVA | | | | | |
| | 5 | TetraEGMME | 43 | Acetoacetyl | Boric acid | ADH | None | C | C |
| | | | | modified PVA | | | | | |
| | 6 | EGMME | 43 | General PVA | Boric acid | ADH | None | C | C |
| | | | | NM-11 | | | | | |
| | 7 | DEGMME | 43 | General PVA | Boric acid | ADH | None | C | C |
| | | | | NM-11 | | | | | |

Abbreviates in the columns of the water-soluble organic solvent in Table 1 above denote as follows;
DEGMME: diethylene glycol monomethyl ether
DEGMBE: diethylene glycol monobutyl ether
DEGMEE: diethylene glycol monoethyl ether
PGMME: propylene glycol monomethyl ether
DPGMME: dipropylene glycol monomethyl ether
DPGMBE: dipropylene glycol monobutyl ether
DEGDME: diethylene glycol dimethyl ether
EGDME: ethylene glycol dimethyl ether
TEGMME: triethylene glycol monomethyl ether
TEGDME: triethylene glycol dimethyl ether
TetraEGMME: tetraethylene glycol monomethyl ether

In Table 1 above, the coating solution A in the column of the crosslinking agent refers to the coating solutions (A1 to A4) for ink receiving layer and the crosslinking agent solution B refers to the crosslinking agent solutions (B1, B2).

As is understood from Table 1 above, when inkjet recording (image printing) was performed on the inkjet recording medium containing the specific water-soluble resin, using the inkjet ink containing the specific water-soluble organic solvent (Examples 1 to 25), the ink density was high and the hue hardly changed. Moreover, when a drying process was further added in the inkjet recording process (Examples 16 to 25), the hue still hardly changed as compared with Examples 1 to 15 not including the drying process.

The invention provides an inkjet recording method that can provide a clear and high density recorded image and that can suppress changes in hue from the hue obtained immediately after image printing. The present invention may namely provide the following items <1> to <10>:

<1> An inkjet recording method comprising recording on an inkjet recording medium having, on a support, an ink receiving layer containing at least inorganic fine particles, polyvinyl alcohol-based polymer having a keto group, and a crosslinking agent, using inkjet ink containing at least a dye, water, and a water-soluble organic solvent in which 40% by mass or more of the water-soluble organic solvent is at least one member selected from the group consisting of ethylene glycol monoalkyl ether, diethylene glycol monoalkyl ether, propylene glycol monoalkyl ether, dipropylene glycol monoalkyl ether, 1,2-alkanediol, ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether.

<2> The inkjet recording method according to the item <1>, wherein the water-soluble organic solvent comprises 1,2-alkanediol, and the 1,2-alkanediol has 2 to 6 carbon atoms.

<3> The inkjet recording method according to the item <1> or the item <2>, wherein the water-soluble organic solvent comprises ethylene glycol monoalkyl ether, diethylene glycol monoalkyl ether, propylene glycol monoalkyl ether, or dipropylene glycol monoalkyl ether, and the ethylene glycol monoalkyl ether, diethylene glycol monoalkyl ether, propylene glycol monoalkyl ether, and dipropylene glycol monoalkyl ether each independently comprise an alkyl group in which a number of carbon atoms is 1 to 5.

<4> The inkjet recording method according to any one of the items <1> to <3>, wherein the water-soluble organic solvent comprises ethylene glycol dialkyl ether, diethylene glycol dialkyl ether, triethylene glycol dialkyl ether, propylene glycol dialkyl ether, dipropylene glycol dialkyl ether, or tripropylene glycol dialkyl ether, and the ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether each independently comprise an alkyl group in which a number of carbon atoms is 1 to 3.

<5> The inkjet recording method according to any one of the items <1> to <4>, wherein the water-soluble organic solvent further comprises glycerin.

<6> The inkjet recording method according to any one of the items <1> to <5>, wherein the dye is a water-soluble dye.

<7> The inkjet recording method according to any one of the items <1> to <6>, wherein the polyvinyl alcohol-based polymer is an acetoacetyl modified polyvinyl alcohol or a diacetone acrylamide modified polyvinyl alcohol.

<8> The inkjet recording method according to any one of the items <1> to <7>, wherein a thickness of the ink receiving layer is 10 μm to 50 μm.

<9> The inkjet recording method according to any one of the items <1> to <8>, further comprising drying the inkjet recording medium after recording.

<10> The inkjet recording method according to any one of the items <1> to <9>, wherein the crosslinking agent comprises at least one water-soluble compound having two or more hydrazido groups or primary amino groups in a molecule thereof.

The foregoing description of the exemplary embodiments of the present invention has been provided for the purposes of illustration and description. It is not intended to be exhaustive or to limit the invention to the precise forms disclosed. The embodiments were chosen and described in order to best explain the principles of the invention and its practical applications, thereby enabling others skilled in the art to understand the invention for various embodiments and with the various modifications as are suited to the particular use contemplated.

All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. It is intended that the scope of the invention be defined by the following claims and their equivalents.

What is claimed is:

1. An inkjet recording method comprising recording on an inkjet recording medium having, on a support, an ink receiving layer comprising at least inorganic fine particles, a polyvinyl alcohol-based polymer having a keto group, and a crosslinking agent, using inkjet ink comprising at least a dye, water, and a water-soluble organic solvent in which 40% by mass or more of the water-soluble organic solvent is at least one member selected from the group consisting of ethylene glycol monoalkyl ether, diethylene glycol monoalkyl ether, propylene glycol monoalkyl ether, dipropylene glycol monoalkyl ether, 1,2-alkanediol, ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether.

2. The inkjet recording method according to claim 1, wherein the water-soluble organic solvent comprises 1,2-alkanediol, and the 1,2-alkanediol has 2 to 6 carbon atoms.

3. The inkjet recording method according to claim 1, wherein the water-soluble organic solvent comprises ethylene glycol monoalkyl ether, diethylene glycol monoalkyl ether, propylene glycol monoalkyl ether, or dipropylene glycol monoalkyl ether, and the ethylene glycol monoalkyl ether, diethylene glycol monoalkyl ether, propylene glycol monoalkyl ether, and dipropylene glycol monoalkyl ether each independently comprise an alkyl group in which a number of carbon atoms is 1 to 5.

4. The inkjet recording method according to claim 1, wherein the water-soluble organic solvent comprises ethylene glycol dialkyl ether, diethylene glycol dialkyl ether, triethylene glycol dialkyl ether, propylene glycol dialkyl ether, dipropylene glycol dialkyl ether, or tripropylene glycol dialkyl ether, and the ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether each independently comprise an alkyl group in which a number of carbon atoms is 1 to 3.

5. The inkjet recording method according to claim 1, wherein the water-soluble organic solvent further comprises glycerin.

6. The inkjet recording method according to claim 1, wherein the dye is a water-soluble dye.

7. The inkjet recording method according to claim 1, wherein the polyvinyl alcohol-based polymer is an acetoacetyl modified polyvinyl alcohol or a diacetone acrylamide modified polyvinyl alcohol.

8. The inkjet recording method according to claim 1, wherein a thickness of the ink receiving layer is 10 μm to 50 μm.

9. The inkjet recording method according to claim 1, further comprising drying the inkjet recording medium after the recording.

10. The inkjet recording method according to claim 1, wherein the crosslinking agent comprises at least one water-soluble compound having two or more hydrazido groups or primary amino groups in a molecule thereof.
